(19) United States
(12) Patent Application Publication
(10) Pub. No.: US 2022/0009312 A1
(43) Pub. Date: Jan. 13, 2022

(54) VIBRATION-ISOLATING DEVICE

(71) Applicant: DENSO CORPORATION, Kariya-city (JP)

(72) Inventors: Kazuhiro HAYASHI, Nisshin-city (JP); Ryo MIYAHARA, Kariya-city (JP); Haruhisa SHIBATA, Kariya-city (JP); Yasutane HIJIKATA, Kariya-city (JP); Kazuhiro TADA, Kariya-city (JP)

(73) Assignee: DENSO CORPORATION, Kariya-city (JP)

(21) Appl. No.: 17/484,372

(22) Filed: Sep. 24, 2021

Related U.S. Application Data
(63) Continuation of application No. PCT/JP2020/008005, filed on Feb. 27, 2020.

(30) Foreign Application Priority Data
Mar. 28, 2019 (JP) 2019-063334

(51) Int. Cl. B60H 1/32; F16F 15/08; F16J 15/10

(52) U.S. Cl. CPC B60H 1/3229; F16M 5/00; F16J 15/102; F16F 15/08

(57) ABSTRACT

A vibration-isolating device includes: a vibration source, which generates vibrations; and at least one vibration-isolating rubber which is fixed to the vibration source. The vibration source is supported by at least one support member that is fixed to a transmission-receiving member through the at least one vibration-isolating rubber. The vibration source and the at least one vibration-isolating rubber are configured such that a difference between a maximum value and a minimum value of resonant frequencies of a structure, which includes the vibration source, the at least one vibration-isolating rubber and the at least one support member, is equal to or smaller than 10 Hz when the vibration source is vibrated in six degrees of freedom. The at least one vibration-isolating rubber includes: 100 parts by mass of silicone rubber; and larger than 0 parts by mass and equal to or smaller than 3 parts by mass of carbon nanotubes.

### CROSS REFERENCE TO RELATED APPLICATIONS

This application is a continuation application of International Patent Application No. PCT/JP2020/008005 filed on Feb. 27, 2020, which designated the U.S. and claims the benefit of priority from Japanese Patent Application No. 2019-63334 filed on Mar. 28, 2019. The entire disclosures of all of the above applications are incorporated herein by reference.

### TECHNICAL FIELD

The present disclosure relates to a vibration-isolating device.

### BACKGROUND

There has been proposed a vibration-isolating device that includes at least one vibration-isolating rubber which limits transmission of vibrations from a vibration source to another member.

### SUMMARY

This section provides a general summary of the disclosure, and is not a comprehensive disclosure of its full scope or all of its features.

According to the present disclosure, there is provided a vibration-isolating device that includes at least one vibration-isolating rubber fixed to a vibration source. The at least one vibration-isolating rubber includes: 100 parts by mass of silicone rubber; and larger than 0 parts by mass and equal to or smaller than 3 parts by mass of carbon nanotubes.

### BRIEF DESCRIPTION OF DRAWINGS

The drawings described herein are for illustrative purposes only of selected embodiments and not all possible implementations, and are not intended to limit the scope of the present disclosure.

FIG. 1 is a side view of a vibration-isolating device of a first embodiment.

FIG. 2 is a side view of the vibration-isolating device of the first embodiment seen from a left side in FIG. 1.

FIG. 3A is a side view of a vibration-isolating rubber shown in FIG. 1 and threaded fasteners joined to the vibration-isolating rubber.

FIG. 3B is a cross-sectional view taken along line IIIB-IIIB in FIG. 3A.

FIG. 3C is a perspective view of the vibration-isolating rubber shown in FIG. 1.

FIG. 4 is a diagram indicating arrangement of the four vibration-isolating rubbers shown in FIG. 1 and a positional relationship among a center of gravity G, an elastic center Sa, a point P, a point Q, a point A, a point B, a point C and a point D.

FIG. 5 is a side view of the vibration-isolating device of the first embodiment for indicating a distance between the point A and the point D and a distance between the point B and the point C in FIG. 4.

FIG. 6 is a side view of the vibration-isolating device of the first embodiment for indicating a distance between the point A and the point B and a distance between the point C and the point D in FIG. 4.

FIG. 7 is a diagram indicating a setting angle between a plane ZYa and an axis Xa of a corresponding one of the vibration-isolating rubbers and a setting angle between a plane XYa and the axis Xa in the first embodiment.

FIG. 8 is a diagram indicating a setting angle between the plane ZYa and the axis Xa of the corresponding vibration-isolating rubber and a setting angle between a plane ZXa and the axis Xa in the first embodiment.

FIG. 9 is a diagram indicating a setting angle between a plane ZYb and an axis Xb of a corresponding one of the vibration-isolating rubbers and a setting angle between a plane XYb and the axis Xb in the first embodiment.

FIG. 10 is a diagram indicating a setting angle between the plane ZYb and the axis Xb of the corresponding vibration-isolating rubber and a setting angle between a plane ZXb and the axis Xb in the first embodiment.

FIG. 11 is a diagram indicating a setting angle between a plane XYd and an axis Xd of a corresponding one of the vibration-isolating rubbers and a setting angle between a plane ZYd and the axis Xd in the first embodiment.

FIG. 12 is a diagram indicating a setting angle between a plane ZXd and the axis Xd of the corresponding vibration-isolating rubber and a setting angle between the plane ZYd and the axis Xd in the first embodiment.

FIG. 13 is a diagram indicating a setting angle between a plane XYc and an axis Xc of a corresponding one of the vibration-isolating rubbers and a setting angle between a plane ZYc and the axis Xc in the first embodiment.

FIG. 14 is a diagram indicating a setting angle between a plane ZXc and the axis Xc of the corresponding vibration-isolating rubber and a setting angle between the plane ZYc and the axis Xc in the first embodiment.

FIG. 15 is a schematic diagram for describing the elastic center of the compressor shown in FIG. 1.

FIG. 16 is a schematic diagram for describing the elastic center of the compressor shown in FIG. 1.

FIG. 17 is a schematic diagram for describing the elastic center of the compressor shown in FIG. 1.

FIG. 18 is a schematic diagram for describing a location of the elastic center and a location of the center of gravity of the compressor shown in FIG. 1.

FIG. 19 is a schematic diagram for describing vibrating directions Y, Z, φ, Ψ of the compressor shown in FIG. 1.

FIG. 20 is a schematic diagram for describing vibrating directions X, θ of the compressor shown in FIG. 1.

FIG. 21 a diagram showing a relationship between a vibration transmissibility and a frequency for each of a device of a first comparative example and a device of a second comparative example.

FIG. 22 is a diagram showing results of a cyclic fatigue evaluation test for a silicone rubber having a CNT mixing ratio of 0 phr, a silicone rubber having a CNT mixing ratio of 1 phr and a silicone rubber having a CNT mixing ratio of 2 phr.

FIG. 23 is a diagram showing results of a viscoelasticity evaluation test for the silicone rubber having the CNT mixing ratio of 0 phr, the silicone rubber having the CNT mixing ratio of 1 phr, the silicone rubber having the CNT mixing ratio of 2 phr and natural rubber.

FIG. 24 is a diagram showing a relationship between the CNT mixing ratio and a geometrical ratio a₁/h of the vibration-isolating rubber.

FIG. 25A is a side view of the vibration-isolating rubber in a case where the geometrical ratio a₁/h is large.

FIG. 25B is a side view of a vibration-isolating rubber for a case where the geometrical ratio a₁/h is smaller than the vibration-isolating rubber shown in FIG. 25A.

FIG. 26 is a diagram showing a relationship between the geometrical ratio a₁/h and a maximum load in a rigidity constant range.

FIG. 27 is a diagram showing a relationship between a load and a displacement in each of a case where the geometrical ratio a₁/h is larger than 0.65 and a case where the geometrical ratio a₁/h is smaller than 0.65.

FIG. 28 is a side view of a vibration-isolating device of a second embodiment.

FIG. 29 is a side view of the vibration-isolating device of the second embodiment seen from a left side in FIG. 28.

FIG. 30 is a top view of an upper support member shown in FIG. 28.

FIG. 31 is a diagram showing a relationship between a frequency and a vibration transmissibility for describing a setting range of resonant frequencies of six vibration modes at a vibration-isolating device of a third embodiment.

### DETAILED DESCRIPTION

There has been proposed a sealing member that includes hydrogenated acrylonitrile-butadiene rubber and carbon nanotubes.

In order to improve a vibration isolation effect of a vibration-isolating device, the inventors of the present application have studied the vibration-isolating device with the following structure. In the following, this vibration-isolating device will be referred to as the vibration-isolating device of the study example.

The vibration-isolating device of the study example is a device at which transmission of vibrations from a vibration source to a member (hereinafter referred to as a transmission-receiving member), which receives the transmission, is limited. This vibration-isolating device includes the vibration source and at least one vibration-isolating rubber while the at least one vibration-isolating rubber is fixed to the vibration source. The vibration source is supported by at least one support member that is fixed to the transmission-receiving member through the at least one vibration-isolating rubber. The vibration source and the at least one vibration-isolating rubber are configured such that resonant frequencies of a structure, which includes the vibration source, the at least one vibration-isolating rubber and the at least one support member, are aggregated into a predetermined single frequency when the vibration source is vibrated in six degrees of freedom.

The vibration-isolating device of the study example can improve the vibration isolation effect in a frequency range, which is higher than the aggregated resonant frequency, in comparison to a previously proposed vibration-isolating device in which the resonant frequencies of the structure are not aggregated. However, the inventors of the present application have found that the vibration-isolating device of the study example reduces the vibration isolation effect in a frequency range of the aggregated resonant frequency.

This issue is not limited to the case where the resonant frequencies of the structure are aggregated into the predetermined single frequency when the vibration source is vibrated in the six degrees of freedom. This issue is expected to occur when a difference between a maximum value and a minimum value of the resonant frequencies of the structure is aggregated within a predetermined range, which is narrower than that of the previously proposed vibration-isolating device.

According to one aspect of the present disclosure, there is provided a vibration-isolating device configured to limit transmission of vibrations from a vibration source to a transmission-receiving member. The vibration-isolating device includes:

the vibration source that is configured to generate the vibrations; and

at least one vibration-isolating rubber that is fixed to the vibration source, wherein:

the vibration source is supported by at least one support member that is fixed to the transmission-receiving member through the at least one vibration-isolating rubber;

the vibration source and the at least one vibration-isolating rubber are configured such that a difference between a maximum value and a minimum value of resonant frequencies of a structure, which includes the vibration source, the at least one vibration-isolating rubber and the at least one support member, is equal to or smaller than 10 Hz when the vibration source is vibrated in six degrees of freedom; and

the at least one vibration-isolating rubber includes:
100 parts by mass of silicone rubber; and
larger than 0 parts by mass and equal to or smaller than 3 parts by mass of carbon nanotubes.

According to this aspect, the resonant frequencies of the structure at the time of vibrating the vibration source in the six degrees of freedom are aggregated. Therefore, the vibration isolation effect in the frequency range higher than the aggregated resonant frequency(ies) can be improved.

Furthermore, according to this aspect, the at least one vibration-isolating rubber includes: 100 parts by mass of the silicone rubber; and larger than 0 parts by mass and equal to or smaller than 3 parts by mass of the carbon nanotubes. In a temperature range of −100° C. to 80° C., a damping coefficient tan δ of this vibration-isolating rubber is larger than a damping coefficient tan δ of a vibration-isolating rubber made of natural rubber. Therefore, the vibration transmissibility at the frequency range of the aggregated resonant frequency(ies) can be further reduced, and thereby the vibration isolation effect can be further improved in comparison to the case where the resonant frequencies of the structure at the time of vibrating the vibration source in the six degrees of freedom are aggregated while the vibration-isolating rubber is made of the natural rubber.

Furthermore, according to another aspect, there is also provided a vibration-isolating device configured to limit transmission of vibrations from a vibration source to a transmission-receiving member. The vibration-isolating device includes:

the vibration source that is configured to generate the vibrations;

at least one primary support member that is fixed to the vibration source and supports the vibration source; and

at least one vibration-isolating rubber that is fixed to a portion of the at least one primary support member which is located on a side that is opposite to the vibration source, wherein:

the vibration source is supported by at least one secondary support member that is fixed to the transmission-receiving member through the at least one vibration-isolating rubber;

the vibration source, the at least one primary support member and the at least one vibration-isolating rubber are configured such that a difference between a maximum value and a minimum value of resonant frequencies of a structure, which includes the vibration source, the at least one primary support member, the at least one vibration-isolating rubber and the at least one secondary support member, is equal to or smaller than 10 Hz when the vibration source is vibrated in six degrees of freedom; and

the at least one vibration-isolating rubber includes:
100 parts by mass of silicone rubber; and
larger than 0 parts by mass and equal to or smaller than 3 parts by mass of carbon nanotubes.

According to this aspect, the resonant frequencies of the structure at the time of vibrating the vibration source in the six degrees of freedom are aggregated. Therefore, the vibration isolation effect in the frequency range higher than the aggregated resonant frequency(ies) can be improved.

Furthermore, according to this aspect, the at least one vibration-isolating rubber includes: 100 parts by mass of the silicone rubber; and larger than 0 parts by mass and equal to or smaller than 3 parts by mass of the carbon nanotubes. In a temperature range of −10° C. to 80° C., the damping coefficient tan δ of this vibration-isolating rubber is smaller than the damping coefficient tan δ of the vibration-isolating rubber made of the natural rubber. Therefore, the vibration transmissibility at the frequency range of the aggregated resonant frequency(ies) can be further reduced, and thereby the vibration isolation effect can be further improved in comparison to the case where the resonant frequencies of the structure at the time of vibrating the vibration source in the six degrees of freedom are aggregated while the vibration-isolating rubber is made of the natural rubber.

Hereinafter, embodiments of present disclosure will be described with reference to drawings. In each of the following embodiments, parts, which are identical to or equivalent to each other, will be indicated with the same reference sign.

### First Embodiment

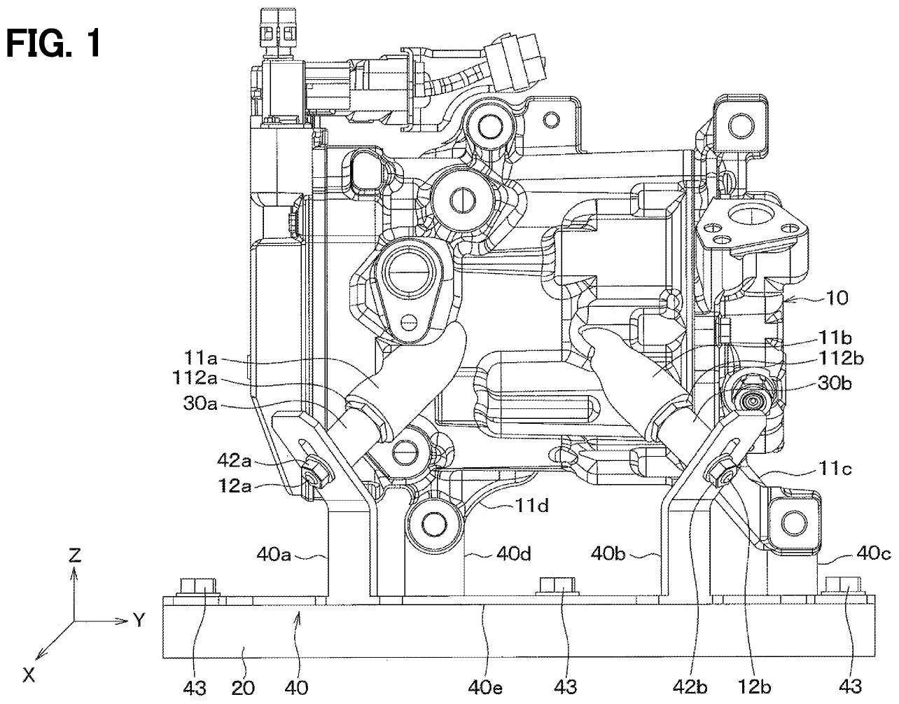

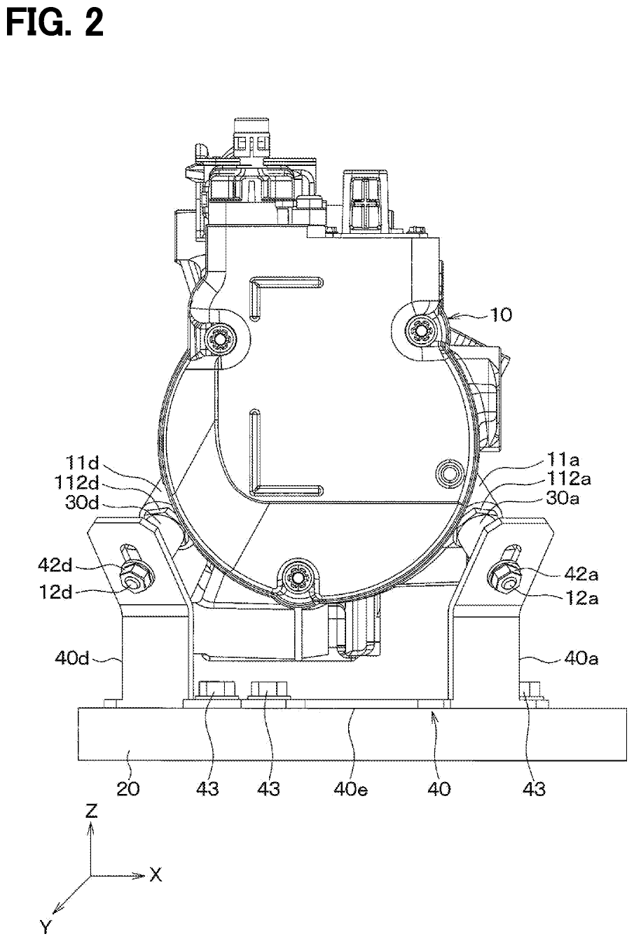

A vibration-isolating device of the present embodiment shown in FIGS. 1 and 2 is a device that limits transmission of vibrations from a compressor 10 to a vehicle body 20. The compressor 10 is a vibration source that generates the vibrations. The compressor 10 is a compressor for a vehicle air conditioning system. In the present embodiment, an electric compressor, which has an electric motor to drive a compression mechanism, is used as the compressor 10. The vehicle body 20 is a transmission-receiving member to which the vibrations are transmitted from the vibration source.

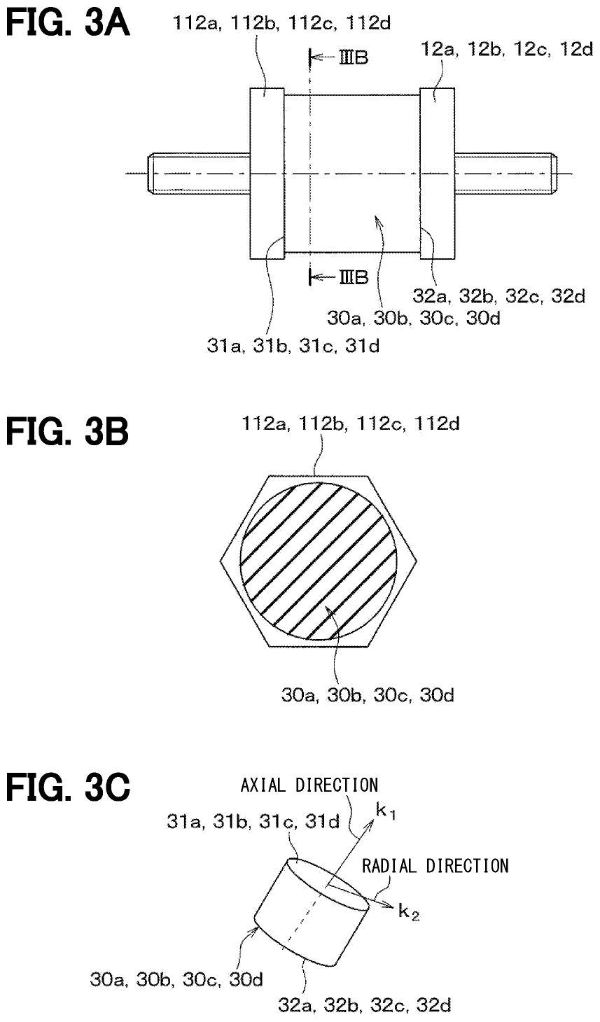

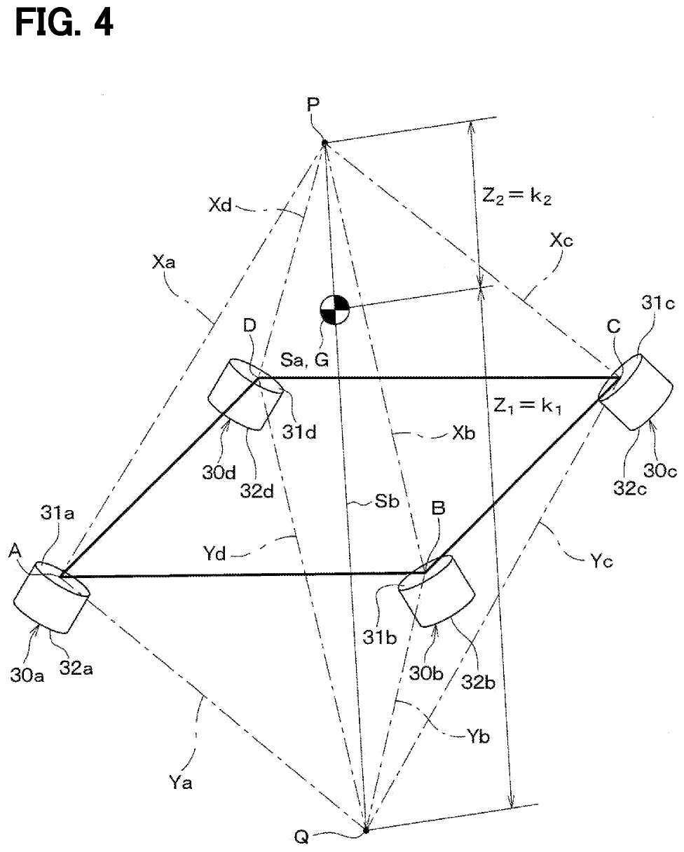

As shown in FIGS. 1, 2, 3A, 3B, 3C and 4, the vibration-isolating device of the present embodiment includes the one compressor 10 and four vibration-isolating rubbers 30a, 30b, 30c, 30d. The vibration-isolating rubber 30c is not shown in FIGS. 1 and 2 but is shown in FIGS. 3A, 3B, 3C and 4. Hereinafter, the four vibration-isolating rubbers 30a, 30b, 30c, 30d will be simply referred to as vibration-isolating rubbers 30a, 30b, 30c, 30d.

The compressor 10 is supported by one support member 40 through the vibration-isolating rubbers 30a, 30b, 30c, 30d. The support member 40 supports the compressor 10 through the vibration-isolating rubbers 30a, 30b, 30c, 30d. The support member 40 includes four legs 40a, 40b, 40c, 40d and one fixing portion 40e while the fixing portion 40e is shaped in a plate form. The four legs 40a, 40b, 40c, 40d and the fixing portion 40e are formed integrally in one-piece. Alternatively, the four legs 40a, 40b, 40c, 40d may be formed as four separate bodies, respectively. In such a case, the four legs 40a, 40b, 40c, 40d correspond to a plurality of support members.

The vibration-isolating rubbers 30a, 30b, 30c, 30d limit the transmission of the vibrations from the compressor 10 to the vehicle body 20 through the support member 40 by elastic deformation of the vibration-isolating rubbers 30a, 30b, 30c, 30d. The vibration-isolating rubbers 30a, 30b, 30c, 30d are made of a common material. Each vibration-isolating rubber 30a, 30b, 30c, 30d includes silicone rubber and carbon nanotubes. Specifically, each vibration-isolating rubber 30a, 30b, 30c, 30d is mainly made of the silicone rubber and the carbon nanotubes. Hereinafter, the carbon nanotubes will be indicated as CNTs. CNT is an abbreviation for carbon nanotube.

The silicone rubber is a silicone resin in a form of rubber. The silicone rubber may also be referred to as silicon rubber. The silicone rubber is obtained from a liquid state thereof by curing it through a polymerization reaction of silicone. Depending on a type of reaction, silicone rubber can be broadly classified into an addition-reaction type and a condensation-reaction type, but either addition-reaction type or condensation-reaction type may be used.

The CNT is a material formed from a graphene sheet having a uniform planar shape rolled into a single-layered or multi-layered coaxial tube. The graphene sheet is a six-membered ring network made of carbon. The CNTs are sometimes referred to as carbon fibers, graphite fibrillar nanotubes, etc. An average diameter of the CNTs is equal to or larger than 10 nm and is equal to or smaller than 20 nm. The average diameter of the CNTs is measured by electron microscopy.

The vibration-isolating rubbers 30a, 30b, 30c, 30d may contain a filler(s) other than the CNTs. The filler(s) may include silica, clay, talc and/or the like.

The CNTs are dispersed in the uncrosslinked silicone rubber. This results in the formation of a mixture of the silicone rubber and the CNTs. A cross-linking agent is added to this mixture, and the silicone rubber is cross-linked. At this time, the silicone rubber is molded into a desired form. Thereby, the vibration-isolating rubbers 30a, 30b, 30c, 30d are manufactured.

Each of the vibration-isolating rubbers 30a, 30b, 30c, 30d is shaped in a circular column (cylinder). The circular column is a column having an axis. An axial direction, which is parallel to the axis, is a height direction of the circular column. A shape of a cross-section of the circular column, which is perpendicular to the axis, is a circle. Here, each of the vibration-isolating rubbers 30a, 30b, 30c, 30d may be shaped in a column that has a cross-section shaped in a square.

An end surface 31a is formed at one end of the vibration-isolating rubber 30a which is located on one side in the axial direction. A threaded fastener 112a is bonded to the end surface 31a of the vibration-isolating rubber 30a. The threaded fastener 112a is threadably fastened to a female-threaded hole formed in the leg 11a of the compressor 10. As described above, the vibration-isolating rubber 30a is fixed to the compressor 10. The vibration-isolating rubber 30a supports the leg 11a of the compressor 10 through the end surface 31a of the vibration-isolating rubber 30a.

An end surface 32a is formed at the other end of the vibration-isolating rubber 30a which is located on the other side in the axial direction. A threaded fastener 12a is bonded to the end surface 32a of the vibration-isolating rubber 30a. A nut 42a is threadably fastened to the threaded fastener 12a in a state where the threaded fastener 12a is inserted through a through-hole of the leg 40a of the support member 40. As described above, the vibration-isolating rubber 30a is installed between the leg 11a of the compressor 10 and the leg 40a of the support member 40.

An end surface 31b is formed at one end of the vibration-isolating rubber 30b which is located on one side in the axial direction. A threaded fastener 112b is bonded to the end surface 31b of the vibration-isolating rubber 30b. The threaded fastener 112b is threadably fastened to a female-threaded hole formed in the leg 11b of the compressor 10. As described above, the vibration-isolating rubber 30b is fixed to the compressor 10. The vibration-isolating rubber 30b supports the leg 11b of the compressor 10 through the end surface 31b of the vibration-isolating rubber 30b.

An end surface 32b is formed at the other end of the vibration-isolating rubber 30b which is located on the other side in the axial direction. A threaded fastener 12b is bonded to the end surface 32b of the vibration-isolating rubber 30b. A nut 42b is threadably fastened to the threaded fastener 12b in a state where the threaded fastener 12b is inserted through a through-hole of the leg 40b of the support member 40. As described above, the vibration-isolating rubber 30b is installed between the leg 11b of the compressor 10 and the leg 40b of the support member 40.

An end surface 31c is formed at one end of the vibration-isolating rubber 30c which is located on one side in the axial direction. A threaded fastener 112c is bonded to the end surface 31c of the vibration-isolating rubber 30c. The threaded fastener 112c is threadably fastened to a female-threaded hole formed in the leg 11c of the compressor 10. As described above, the vibration-isolating rubber 30c is fixed to the compressor 10. The vibration-isolating rubber 30c supports the leg 11c of the compressor 10 through the end surface 31c of the vibration-isolating rubber 30c.

An end surface 32c is formed at the other end of the vibration-isolating rubber 30c which is located on the other side in the axial direction. A threaded fastener 12c is bonded to the end surface 32c of the vibration-isolating rubber 30c. A nut (not shown) is threadably fastened to the threaded fastener 12c in a state where the threaded fastener 12c is inserted through a through-hole of the leg 40c of the support member 40. As described above, the vibration-isolating rubber 30c is installed between the leg 11c of the compressor 10 and the leg 40c of the support member 40.

An end surface 31d is formed at one end of the vibration-isolating rubber 30d which is located on one side in the axial direction. A threaded fastener 112d is bonded to the end surface 31d of the vibration-isolating rubber 30d. The threaded fastener 112d is threadably fastened to a female-threaded hole formed in the leg 11d of the compressor 10. As described above, the vibration-isolating rubber 30d is fixed to the compressor 10. The vibration-isolating rubber 30d supports the leg 11d of the compressor 10 through the end surface 31d of the vibration-isolating rubber 30d.

An end surface 32d is formed at the other end of the vibration-isolating rubber 30d which is located on the other side in the axial direction. A threaded fastener 12d is bonded to the end surface 32d of the vibration-isolating rubber 30d. A nut 42d is threadably fastened to the threaded fastener 12d in a state where the threaded fastener 12d is inserted through a through-hole of the leg 40d of the support member 40. As described above, the vibration-isolating rubber 30d is installed between the leg 11d of the compressor 10 and the leg 40d of the support member 40.

The fixing portion 40e of the support member 40 of the present embodiment is fixed to the vehicle body 20 with fasteners 43, such as bolts. Thereby, the support member 40 is fixed to the vehicle body 20.

Next, there will be described a positional relationship in XYZ coordinates between a center of gravity G, which is a center of gravity of the compressor 10, and the vibration-isolating rubbers 30a, 30b, 30c, 30d. As shown in FIGS. 1 and 2, a Z axis of the XYZ coordinates coincides with a top-to-bottom direction in a state where the compressor 10 is installed to the vehicle body 20. The Z axis may not coincide with the top-to-bottom direction in the state where the compressor 10 is installed to the vehicle body 20.

As shown in FIG. 4, an axis of the vibration-isolating rubber 30a is defined as an axis Xa. A point of the end surface 31a of the vibration-isolating rubber 30a, which overlaps the axis Xa, is defined as a reference point A. The reference point A is an intersecting point where the axis Xa intersects the end surface 31a. An axis of the vibration-isolating rubber 30b is defined as an axis Xb. A point of the end surface 31b of the vibration-isolating rubber 30b, which overlaps the axis Xb, is defined as a reference point B. The reference point B is an intersecting point where the axis Xb intersects the end surface 31b. An axis of the vibration-isolating rubber 30c is defined as an axis Xc. A point of the end surface 31c of the vibration-isolating rubber 30c, which overlaps the axis Xc, is defined as a reference point C. The reference point C is an intersecting point where the axis Xc intersects the end surface 31c. An axis of the vibration-isolating rubber 30d is defined as an axis Xd. A point of the end surface 31d of the vibration-isolating rubber 30d, which overlaps the axis Xd, is defined as a reference point D. The reference point D is an intersecting point where the axis Xd intersects the end surface 31d.

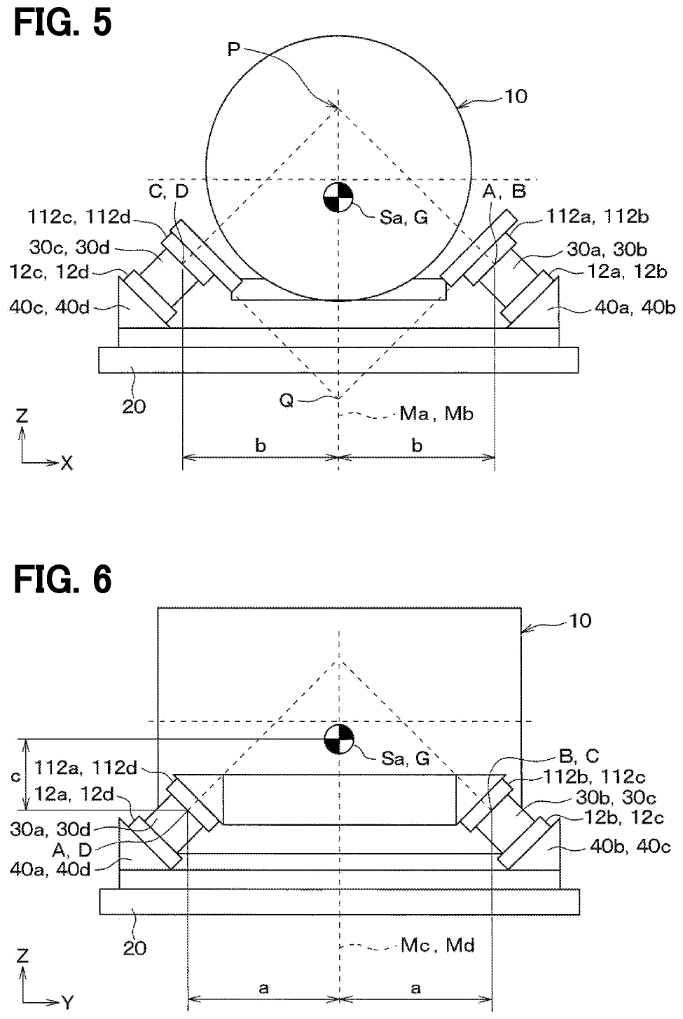

When the vibration-isolating rubbers 30a, 30d are viewed in the axial direction of the Y axis, as shown in FIG. 5, the vibration-isolating rubbers 30a, 30d are symmetric with respect to a virtual line Ma which overlaps the center of gravity G and is parallel to the Z axis at a location between the vibration-isolating rubbers 30a, 30d. Therefore, a dimension b measured between the vibration-isolating rubber 30a and the virtual line Ma and a dimension b measured between the vibration-isolating rubber 30d and the virtual line Ma coincide with each other.

When the vibration-isolating rubbers 30b, 30c are viewed in the axial direction of the Y axis, as shown in FIG. 5, the vibration-isolating rubbers 30b, 30c are symmetric with respect to a virtual line Mb which overlaps the center of gravity G and is parallel to the Z axis at a location between the vibration-isolating rubbers 30b, 30c. Therefore, a dimension b measured between the vibration-isolating rubber 30b and the virtual line Mb and a dimension b measured between the vibration-isolating rubber 30c and the virtual line Mb coincide with each other.

When the vibration-isolating rubbers 30a, 30b are viewed in the axial direction of the X axis, as shown in FIG. 6, the vibration-isolating rubbers 30a, 30b are symmetric with respect to a virtual line Mc which overlaps the center of gravity G and is parallel to the Z axis at a location between the vibration-isolating rubbers 30a, 30b. Therefore, a dimension a measured between the vibration-isolating rubber 30a and the virtual line Mc and a dimension a measured between the vibration-isolating rubber 30b and the virtual line Mc coincide with each other.

When the vibration-isolating rubbers 30c, 30d are viewed in the axial direction of the X axis, as shown in FIG. 6, the vibration-isolating rubbers 30c, 30d are symmetric with respect to a virtual line Md which overlaps the center of gravity G and is parallel to the Z axis at a location between the vibration-isolating rubbers 30c, 30d. Therefore, a dimension a measured between the vibration-isolating rubber 30c and the virtual line Md and a dimension a measured between the vibration-isolating rubber 30d and the virtual line Md coincide with each other.

In the present embodiment, the reference points A, B, C, D of the vibration-isolating rubbers 30a, 30b, 30c, 30d are all located in one common plane that is parallel to the X axis and the Y axis. With reference to FIG. 6, a shortest distance between the common plane, at which all of the reference points A, B, C, D are located, and the center of gravity G, is defined as a dimension c. The dimensions a, b, c, which are set in the above-described manner, will be referred to as a mounting position (a, b, c) of the vibration-isolating rubbers 30a, 30b, 30c, 30d.

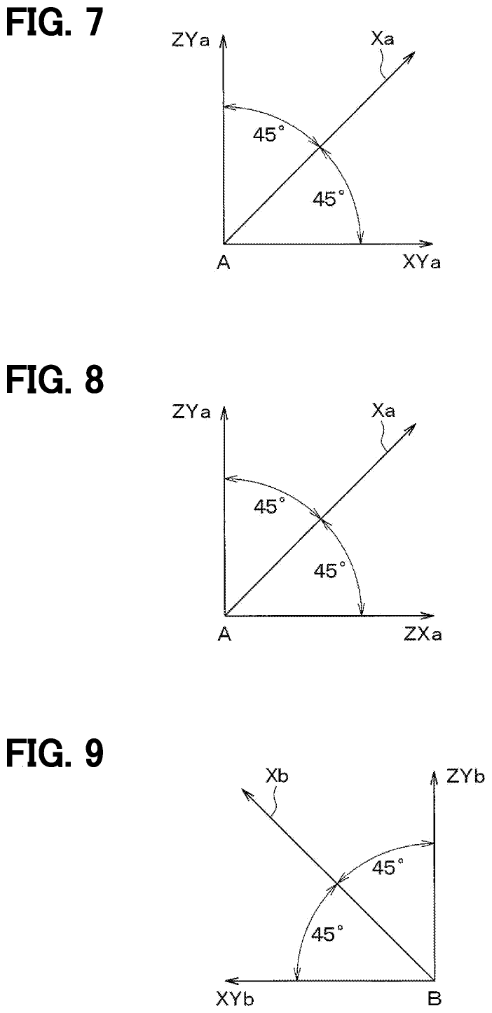

A plane, which includes the reference point A and is parallel to the X axis and the Y axis, will be hereinafter referred to as a plane XYa. A plane, which includes the reference point A and is parallel to the Z axis and the Y axis, will be hereinafter referred to as a plane ZYa. As shown in FIG. 7, an angle, which is defined between the axis Xa and the plane XYa and is measured in the clockwise direction from the axis Xa to the plane XYa, is 45 degrees. An angle, which is defined between the plane ZYa and the axis Xa and is measured in the clockwise direction from the plane ZYa to the axis Xa, is 45 degrees.

A plane, which includes the reference point A and is parallel to the Y axis and the Z axis, will be hereinafter referred to as a plane ZYa. A plane, which includes the reference point A and is parallel to the X axis and the Z axis, will be hereinafter referred to as a plane ZXa. As shown in FIG. 8, an angle, which is defined between the axis Xa and the plane ZYa and is measured in the clockwise direction from the plane ZYa to the axis Xa, is 45 degrees. An angle, which is defined between the axis Xa and the plane ZXa and is measured in the clockwise direction from the axis Xa to the plane ZXa, is 45 degrees.

A plane, which includes the reference point B and is parallel to the X axis and the Y axis, will be hereinafter referred to as a plane XYb. A plane, which includes the reference point B and is parallel to the Z axis and the Y axis, will be hereinafter referred to as a plane ZYb. As shown in FIG. 9, an angle, which is defined between the axis Xb and the plane XYb and is measured in the counterclockwise direction from the axis Xb to the plane XYb, is 45 degrees. An angle, which is defined between the plane ZYb and the axis Xb and is measured in the counterclockwise direction from the plane ZYb to the axis Xb, is 45 degrees.

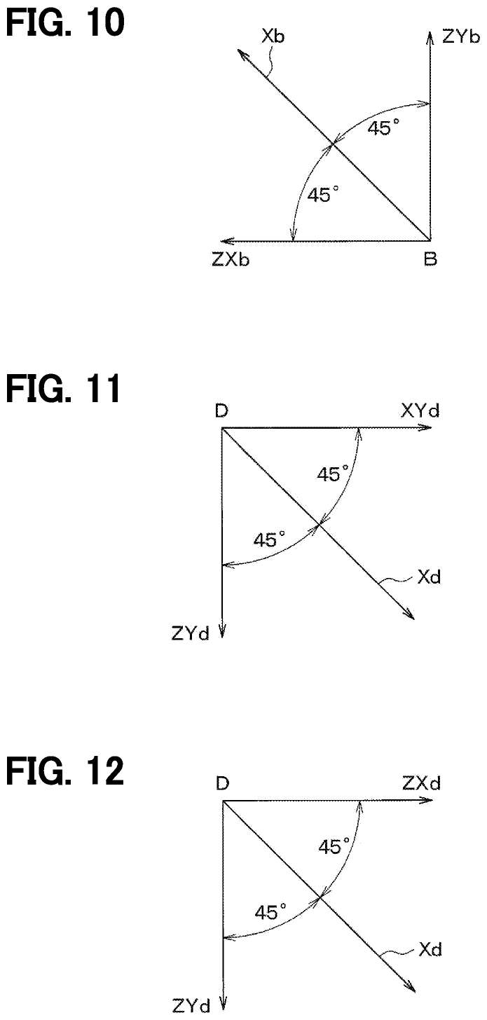

A plane, which includes the reference point B and is parallel to the Y axis and the Z axis, will be hereinafter referred to as a plane ZYb. A plane, which includes the reference point B and is parallel to the X axis and the Z axis, will be hereinafter referred to as a plane ZXb. As shown in FIG. 10, an angle, which is defined between the axis Xb and the plane ZYb and is measured in the counterclockwise direction from the plane ZYb to the axis Xb, is 45 degrees. An angle, which is defined between the axis Xb and the plane ZXb and is measured in the counterclockwise direction from the axis Xb to the plane ZXb, is 45 degrees.

A plane, which includes the reference point D and is parallel to the X axis and the Y axis, will be hereinafter referred to as a plane XYd. A plane, which includes the reference point D and is parallel to the Z axis and the Y axis, will be hereinafter referred to as a plane ZYd. As shown in FIG. 11, an angle, which is defined between the axis Xd and the plane XYd and is measured in the counterclockwise direction from the axis Xd to the plane XYd, is 45 degrees. An angle, which is defined between the plane ZYd and the axis Xd and is measured in the counterclockwise direction from the plane ZYd to the axis Xd, is 45 degrees.

A plane, which includes the reference point D and is parallel to the Y axis and the Z axis, will be hereinafter referred to as a plane ZYd. A plane, which includes the reference point D and is parallel to the X axis and the Z axis, will be hereinafter referred to as a plane ZXd. As shown in FIG. 12, an angle, which is defined between the axis Xd and the plane ZYd and is measured in the counterclockwise direction from the plane ZYd to the axis Xd, is 45 degrees. An angle, which is defined between the axis Xd and the plane ZXd and is measured in the counterclockwise direction from the axis Xd to the plane ZXd, is 45 degrees.

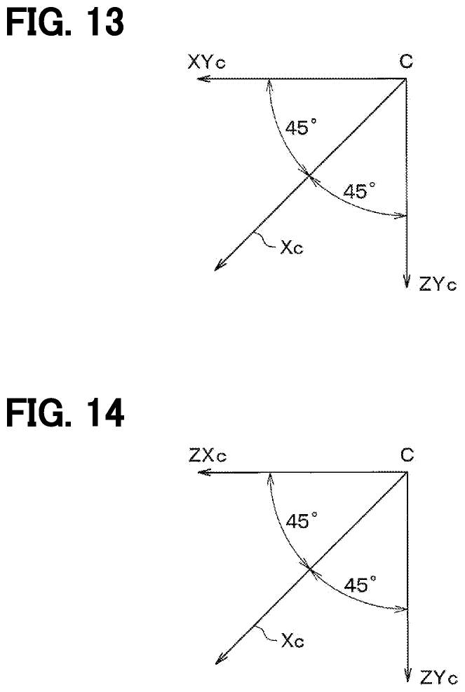

A plane, which includes the reference point C and is parallel to the X axis and the Y axis, will be hereinafter referred to as a plane XYc. A plane, which includes the reference point C and is parallel to the Z axis and the Y axis, will be hereinafter referred to as a plane ZYc. As shown in FIG. 13, an angle, which is defined between the axis Xc and the plane XYc and is measured in the clockwise direction from the axis Xc to the plane XYc, is 45 degrees. An angle, which is defined between the plane ZYc and the axis Xc and is measured in the clockwise direction from the plane ZYc to the axis Xc, is 45 degrees.

A plane, which includes the reference point C and is parallel to the Y axis and the Z axis, will be hereinafter referred to as a plane ZYc. A plane, which includes the reference point C and is parallel to the X axis and the Z axis, will be hereinafter referred to as a plane ZXc. As shown in FIG. 14, an angle, which is defined between the axis Xc and the plane ZYc and is measured in the clockwise direction from the plane ZYc to the axis Xc, is 45 degrees. An angle, which is defined between the axis Xc and the plane ZXc and is measured in the clockwise direction from the axis Xc to the plane ZXc, is 45 degrees.

The setting angles of the axes Xa, Xb, Xc, Xd are set in the above-described manner.

Next, as shown in FIG. 4, a line, which is perpendicular to the axis Xa at the reference point A in the vibration-isolating rubber 30a, will be referred to as a line Ya. The line Ya is a line that extends in a radial direction about the axis Xa. A line, which is perpendicular to the axis Xb at the reference point B in the vibration-isolating rubber 30b, will be referred to as a line Yb. The line Yb is a line that extends in a radial direction about the axis Xb. A line, which is perpendicular to the axis Xc at the reference point C in the vibration-isolating rubber 30c, will be referred to as a line Yc. The line Yc is a line that extends in a radial direction about the axis Xc. A line, which is perpendicular to the axis Xd at the reference point D in the vibration-isolating rubber 30d, will be referred to as a line Yd. The line Yd is a line that extends in a radial direction about the axis Xd.

A point Q is an intersecting point of four planes, i.e., a virtual plane, which includes the reference point A and is perpendicular to the axis Xa, a virtual plane, which includes the reference point B and is perpendicular to the axis Xb, a virtual plane, which includes the reference point C and is perpendicular to the axis Xc, and a virtual plane, which includes the reference point D and is perpendicular to the axis Xd. The line Ya is a virtual straight line that is perpendicular to the axis Xa at the reference point A and extends through the point Q. The line Yb is a virtual straight line that is perpendicular to the axis Xb at the reference point B and extends through the point Q. The line Yc is a virtual straight line that is perpendicular to the axis Xc at the reference point C and extends through the point Q. The line Yd is a virtual straight line that is perpendicular to the axis Xd at the reference point D and extends through the point Q.

Here, the shear rigidity of the vibration-isolating rubber 30a in the axial direction thereof, the shear rigidity of the vibration-isolating rubber 30b in the axial direction thereof, the shear rigidity of the vibration-isolating rubber 30c in the axial direction thereof and the shear rigidity of the vibration-isolating rubber 30d in the axial direction thereof are equal to each other. Hereinafter, as shown in FIG. 3C, the shear rigidity of each of the vibration-isolating rubbers 30a, 30b, 30c, 30d in the axial direction thereof will be defined as a rigidity k₁.

In the vibration-isolating rubber 30a, the shear rigidity in the radial direction perpendicular to the axial direction is constant all around the axis Xa. In the vibration-isolating rubber 30b, the shear rigidity in the radial direction perpendicular to the axial direction is constant all around the axis Xb. In the vibration-isolating rubber 30c, the shear rigidity in the radial direction perpendicular to the axial direction is constant all around the axis Xc. In the vibration-isolating rubber 30d, the shear rigidity in the radial direction perpendicular to the axial direction is constant all around the axis Xd.

As shown in FIG. 3C, the shear rigidity of the vibration-isolating rubber 30a in the radial direction thereof, the shear rigidity of the vibration-isolating rubber 30b in the radial direction thereof, the shear rigidity of the vibration-isolating rubber 30c in the radial direction thereof and the shear rigidity of the vibration-isolating rubber 30d in the radial direction thereof are identical and are respectively defined as a rigidity k₂. In other words, in each of the vibration-isolating rubbers 30a, 30b, 30c, 30d, the share rigidity in a first direction, which is perpendicular to the axial direction, and the share rigidity in a second direction, which is perpendicular to both of the axial direction and the first direction, are equal to each other and are respectively set to be the rigidity k₂. This is true not only when the shape of the vibration-isolating rubber 30a, 30b, 30c, 30d is the circular column having the circular cross-section, but also when the shape of the vibration-isolating rubber 30a, 30b, 30c, 30d is the square column having the square cross-section.

In the present embodiment, as shown in FIG. 4, the position and the orientation of each of the vibration-isolating rubbers 30a, 30b, 30c, 30d are set such that the axes Xa, Xb, Xc, Xd intersect with each other at the point P, and the lines Ya, Yb, Yc, Yd intersect with each other at the point Q. At this time, there is formed a tetrahedral pyramid (hereinafter referred to as an upper tetrahedral pyramid) that is a first pentahedron which has five vertices at the points P, A, B, C, D, respectively. The points Q, A, B, C, D form a tetrahedral pyramid (hereinafter referred to as a lower tetrahedral pyramid) that is a second pentahedron.

The center of gravity G of the compressor 10 of the present embodiment is located within a region formed by combining the upper tetrahedral pyramid and the lower tetrahedral pyramid together. Specifically, a line segment Sb, which connects between the point P and the point Q, includes the center of gravity G. A distance measured between the point P and the center of gravity G along the line segment Sb, is defined as a distance Z2, and a distance measured between the center of gravity G and the point Q along the line segment Sb is defined as a distance Z1. In such a case, Z1/Z2 coincides with k₁/k₂. This allows the center of gravity G of the compressor 10 to coincide with the elastic center Sa of the compressor 10.

Next, the elastic center Sa of the compressor 10 will be described.

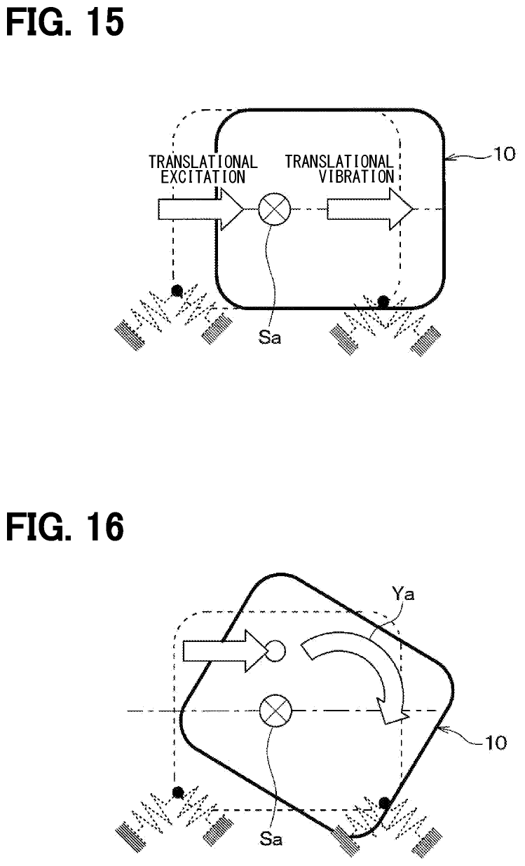

First, as shown in FIG. 15, translational vibration is applied to a specific part of the compressor 10. At this time, the elastic center Sa is the specific part of the compressor 10 where although translational vibration is generated, swing vibration is not generated.

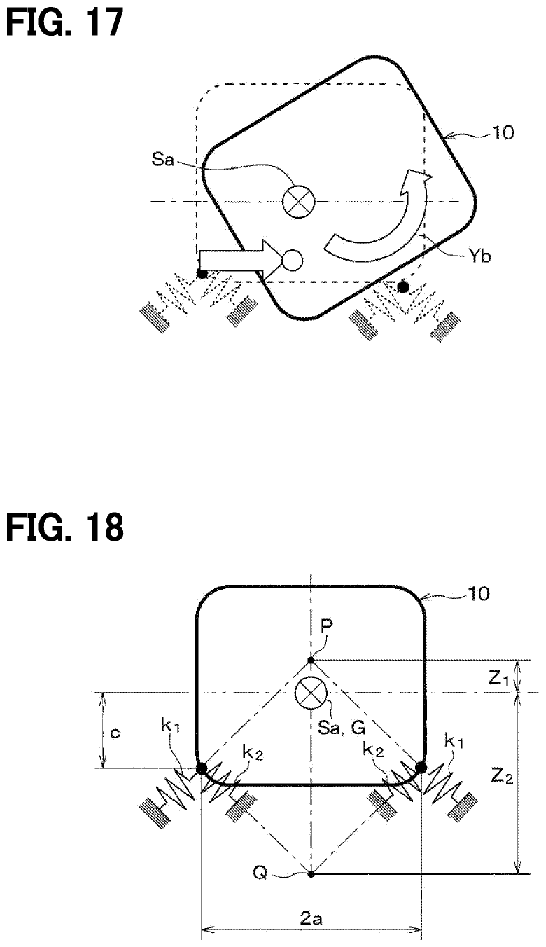

Furthermore, as shown in FIGS. 16 and 17, the translational vibration is also applied to another part of the compressor 10, which is other than the elastic center. At this time, the translational vibration and the swing vibration are generated at the compressor 10.

For example, as shown in FIG. 16, the translational vibration is applied to an upper side of the compressor 10 which is located on the upper side of the elastic center Sa. At this time, the translational vibration and the swing vibration are generated at the compressor 10. Here, the swing vibration is a rotational vibration about the elastic center Sa as indicated by an arrow Ya.

Furthermore, as shown in FIG. 17, the translational vibration is applied to a lower part of the compressor 10 which is located on the lower side of the elastic center Sa. At this time, the translational vibration and the swing vibration are generated at the compressor 10. Here, the swing vibration is a rotational vibration about the elastic center Sa as indicated by an arrow Yb.

As described above, the elastic center Sa is the specific part of the compressor 10 where the swing vibration is not generated although the translational vibration is generated at the time of applying the translational vibration to the specific part.

Here, the position of the elastic center Sa of the compressor 10 is determined based on the mounting position (a, b, c) of the vibration-isolating rubbers 30a, 30b, 30c, 30d and the rigidities k₁, k₂. As shown in FIG. 18, the elastic center Sa, which is determined in the above-described manner, and the center of gravity G are set to coincide with each other.

Therefore, coupling of the translational vibration and the swing vibration is limited in the six directions, and the translational vibration and the swing vibration are independently generated in the six directions. Thus, resonant frequencies fx, fy, fz, fφ, fΨ, fθ of the six vibration modes are as follows.

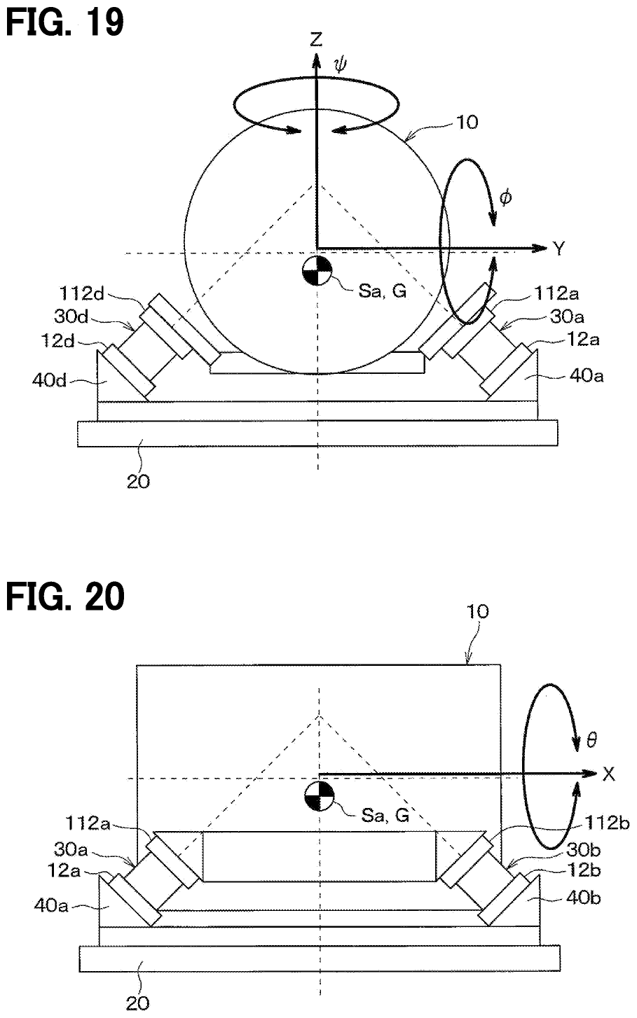

Specifically, as shown in FIG. 19, the resonant frequency fy is a resonant frequency of the translational vibration that travels translationally along the Y axis which extends from the elastic center Sa (i.e., the center of gravity G) in the Y direction. The resonant frequency fφ is a resonant frequency of the vibration that rotates (i.e., swings) in the φ direction about the Y axis.

As shown in FIG. 19, the resonant frequency fz is a resonant frequency of the translational vibration that travels translationally along the Z axis which extends from the elastic center Sa (i.e., the center of gravity G) in the Z direction. The resonant frequency fΨ is a resonant frequency of the vibration that rotates (i.e., swings) in the Ψ direction about the Z axis.

As shown in FIG. 20, the resonant frequency fx is a resonant frequency of the translational vibration that travels translationally along the X axis which extends from the elastic center Sa (i.e., the center of gravity G) in the X direction. The resonant frequency fθ is a resonant frequency of the vibration that rotates (i.e., swings) in the θ direction about the X axis.

Here, when the axis Xa is used as any one of the axes Xa, Xb, Xc, Xd, a direction vector of the axis Xa is set to be (i, j, h). Hereinafter, the resonant frequencies fx, fy, fz, fφ, fΨ, fθ will be respectively expressed by using the direction vector (i, j, h), the mounting position (a, b, c) of the vibration-isolating rubbers 30a, 30b, 30c, 30d and the rigidities k₁, k₂.

First of all, p and q are defined by an equation 1 and an equation 2 which use the direction vector (i, j, h). Furthermore, a mass of the compressor 10 is denoted by m, an inertia moment of the compressor 10 in the X direction is denoted by Ix. An inertia moment of the compressor 10 in the Y direction is denoted by Iy, and an inertia moment of the compressor 10 in the Z direction is denoted by Iz.

$$\begin{matrix}\frac{h}{j} = p & [ Equation 1 ] \\ \frac{i}{j} = q & [ Equation 2 ]\end{matrix}$$

Next, a relationship among, p, q, the mounting position (a, b, c) and the rigidities k₁, k₂ is expressed by an equation 3 and an equation 4.

$$\begin{matrix}\frac{{k}_{2}}{{k}_{1}} {p}^{2} + \frac{a}{c} ( \frac{{k}_{2}}{{k}_{1}} - 1 ) p q + {p}^{2} + \frac{{k}_{2}}{{k}_{1}} = 0 & [ Equation 3 ] \\ \frac{{k}_{2}}{{k}_{1}} {p}^{2} + \frac{b}{c} ( \frac{{k}_{2}}{{k}_{1}} - 1 ) p + \frac{{k}_{2}}{{k}_{1}} {q}^{2} + 1 = 0 & [ Equation 4 ]\end{matrix}$$

Furthermore, a relationship between p and q is expressed by an equation 5.

R=p²+q²+1 [Equation 5]

Here, the resonant frequencies fx, fy, fz, fφ, fΨ, fθ are respectively expressed by equations 6-11 by using p, q, R of the equation 5, the mounting position (a, b, c) and the rigidities k₁, k₂.

$$\begin{matrix}{f}_{x} = \frac{1}{2 π} \sqrt{\frac{4 {k}_{1}}{m R} ( {q}^{2} + \frac{{k}_{2}}{{k}_{1}} ( {p}^{2} + 1 ) )} & [ Equation 6 ] \\ {f}_{y} = \frac{1}{2 π} \sqrt{\frac{4 {k}_{1}}{m R} ( 1 + \frac{{k}_{2}}{{k}_{1}} ( {p}^{2} + {p}^{2} ) )} & [ Equation 7 ] \\ {f}_{z} = \frac{1}{2 π} \sqrt{\frac{4 {k}_{1}}{m R} ( {p}^{2} + \frac{{k}_{2}}{{k}_{1}} ( {q}^{2} + 1 ) )} & [ Equation 8 ] \\ {f}_{θ} = \frac{1}{2 π} \sqrt{\frac{4 {k}_{1}}{{I}_{x} R} [ {c}^{2} \{ 1 + \frac{{k}_{2}}{{k}_{1}} ( {p}^{2} + {q}^{2} ) \} + {b}^{2} \{ {p}^{2} + \frac{{k}_{2}}{{k}_{1}} ( 1 + {q}^{2} ) \} - 2 pbc ( 1 - \frac{{k}_{2}}{{k}_{1}} ) ]} & [ Equation 9 ] \\ {f}_{ϕ} = \frac{1}{2 π} \sqrt{\frac{4 {k}_{1}}{{I}_{y} R} [ {a}^{2} \{ {p}^{2} + \frac{{k}_{2}}{{k}_{1}} ( 1 + {q}^{2} ) \} + {c}^{2} \{ {q}^{2} + \frac{{k}_{2}}{{k}_{1}} ( 1 + {q}^{2} ) \} - 2 pbca ( 1 - \frac{{k}_{2}}{{k}_{1}} ) \}} & [ Equation 10 ] \\ {f}_{ψ} = \frac{1}{2 π} \sqrt{\frac{4 {k}_{1}}{{I}_{z} R} [ {b}^{2} \{ {q}^{2} + \frac{{k}_{2}}{{k}_{1}} ( {p}^{2} + 1 ) \} + {a}^{2} \{ 1 + \frac{{k}_{2}}{{k}_{1}} ( {p}^{2} + {q}^{2} ) \} - 2 qa ( 1 - \frac{{k}_{2}}{{k}_{1}} ) \}} & [ Equation 11 ]\end{matrix}$$

In the present embodiment, the direction vector (i, h, j), the position (a, b, c), p, q, the mass m of the compressor 10, the inertia moments Ix, Iy, Iz and the rigidities k₁, k₂ are respectively set to its optimal value. In this way, the resonant frequencies fx, fy, fz, fφ, fΨ, fθ coincide with each other, as indicated by an Equation 12.

fₓ=f_{y}=f_{z}=f_{θ}=f_{ϕ}=f_{ψ} [Equation 12]

The resonant frequencies fx, fy, fz, fφ, fΨ, fθ in this embodiment are set to achieve both the durability and the vibration isolation performance of the vibration-isolating rubbers 30a, 30b, 30c, 30d. The vibration isolation performance is the performance that limits transmission of the vibrations generated by the compressor 10 to the vehicle body 20.

In the present embodiment, as shown in FIGS. 7 to 14, the setting angle of each of the axes Xa, Xb, Xc, Xd is set to 45 degrees, so an equation 13, an equation 14 and an equation 15 are valid. In the present embodiment, in the four equations, i.e., the equation 9, the equation 10, the equation 11 and the equation 15, the direction vector (i, h, j), the position (a, b, c), p, q, the mass m of the compressor 10, the inertia moments Ix, Iy, Iz and the rigidities k₁, k₂ are respectively set to its optimal value.

$$\begin{matrix}p = q = 1 & [ Equation 13 ] \\ R = 3 & [ Equation 14 ] \\ {f}_{x} = {f}_{y} = {f}_{z} = \frac{1}{2 π} \sqrt{\frac{4 {k}_{1}}{3 m} ( 1 + 2 \frac{{k}_{2}}{{k}_{1}} )} & [ Equation 15 ]\end{matrix}$$

The setting of the setting angle of each of the axes Xa, Xb, Xc, Xd to 45 degrees may be explained as follows. As shown in FIG. 4, the position and the orientation of each of the vibration-isolating rubbers 30a, 30b, 30c, 30d are set such that the axes Xa, Xb, Xc, Xd intersect with each other at the point P. At this time, the axes Xa, Xb, Xc, Xd of the vibration-isolating rubbers 30a, 30b, 30c, 30d are projected onto an X-Y plane, which includes the reference points A, B, C, D and is parallel to the X axis and the Y axis, in a direction parallel to the Z axis. At this time, an angle of each of the axes Xa, Xb, Xc, Xd relative to the X axis is 45 degrees. Similarly, the axes Xa, Xb, Xc, Xd are projected onto a Y-Z plane, which includes the reference points A, B, C, D and is parallel to the Y axis and the Z axis, in a direction parallel to the X axis. At this time, an angle of each of the axes Xa, Xb, Xc, Xd relative to the Y axis is 45 degrees. Similarly, the axes Xa, Xb, Xc, Xd are projected onto a Z-X plane, which includes the reference points A, B, C, D and is parallel to the Z axis and the X axis, in a direction parallel to the Y axis. At this time, an angle of each of the axes Xa, Xb, Xc, Xd relative to the Z axis is 45 degrees.

When the compressor 10 is in operation, vibrations are generated in six degrees of freedom in the compressor 10. Specifically, the vibration, which travels translationally along the X axis, the vibration, which swings about the X axis, the vibration, which travels translationally along the Y axis, the vibration, which swings about the Y axis, the vibration, which travels translationally along the Z axis, and the vibration, which swing about the Z axis, are generated in the compressor 10. Also, when the vehicle is running, vibrations are applied from the vehicle body 20 to the compressor 10 in six degrees of freedom.

In the present embodiment, the center of gravity G of the compressor 10 coincides with the elastic center Sa of the compressor 10. Therefore, the translational vibrations and the swing vibrations are generated independently in the six directions. Therefore, the resonant frequencies fx, fy, fz, fφ, fΨ, fθ of the six vibration modes can be expressed by the above equations.

The compressor 10 and the vibration-isolating rubbers 30a, 30b, 30c, 30d are set, i.e., are configured such that the resonant frequencies fx, fy, fz, fφ, fΨ, fθ of the six vibration modes are aggregated into a predetermined single frequency fa, i.e., are respectively set to the predetermined single frequency fa. In other words, the mass of the compressor 10 and the rigidity and the position of the respective vibration-isolating rubbers 30a, 30b, 30c, 30d are set. More specifically, the direction vector (i, h, j), the position (a, b, c), p, q, the mass m, the inertia moments Ix, Iy, Iz and the rigidities k₁, k₂ are respectively set to its optimal value, so that the resonant frequencies fx, fy, fz, fφ, fΨ, fθ match the predetermined single frequency fa. With respect to the setting of the mass m of the compressor 10, a weight may be added to the compressor 10 to set the mass m of the compressor 10 to its optimal value.

The resonant frequencies fx, fy, fz, fφ, fΨ, fθ of the six vibration modes are the resonant frequencies of the structure at the time of vibrating the compressor 10 in the six degrees of freedom. This structure includes the compressor 10, the vibration-isolating rubbers 30a, 30b, 30c, 30d and the support member 40. The vibrating of the compressor 10 in the six degrees of freedom means vibrating of the compressor 10 in six directions, i.e., three directions, each of which is parallel to the corresponding one of the three mutually orthogonal axes, and three rotational directions, each of which is around a corresponding one of the three mutually orthogonal axes. The vibrating of the compressor 10 includes both vibrating of the compressor 10 due to its own excitation force and vibrating of the compressor 10 due to an external excitation force.

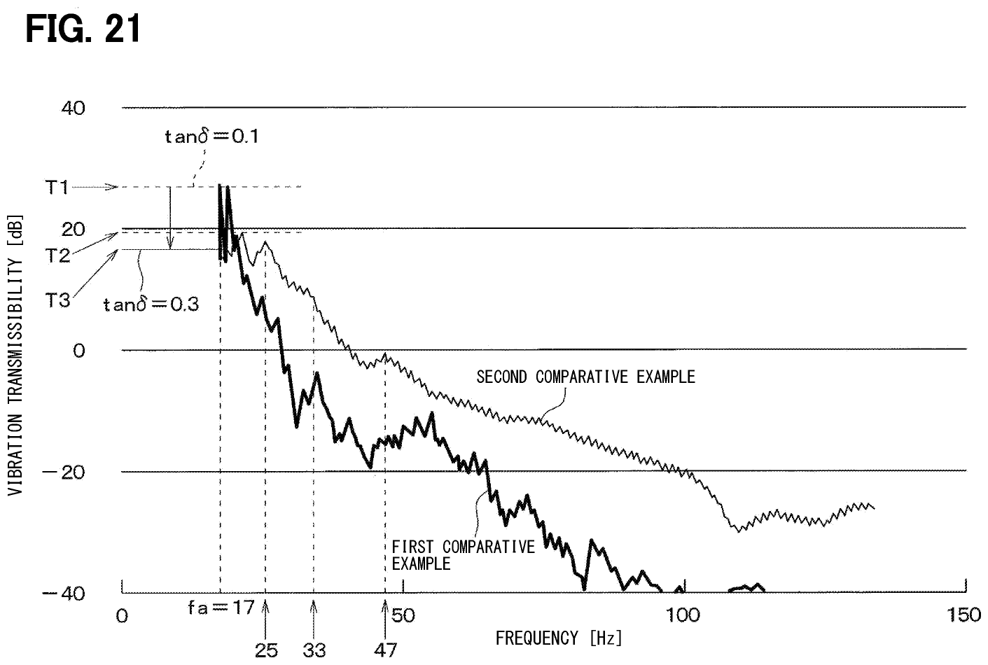

Now, there will be described a case where the vibration-isolating rubbers 30a, 30b, 30c, 30d are made of natural rubber unlike the present embodiment. FIG. 21 shows a relationship between the frequency and the vibration transmissibility for each of a device of a first comparative example and a device of a second comparative example.

The device of the first comparative example differs from the vibration-isolating device of the first embodiment with respect to that the vibration-isolating rubbers 30a, 30b, 30c, 30d of the first comparative example are made of the natural rubber. The rest of the structure of the device of the first comparative example is the same as that of the vibration-isolating device of the first embodiment.

The device of the second comparative example differs from the first embodiment with respect to that the vibration-isolating rubbers are made of the natural rubber, and the positions of the vibration-isolating rubbers are different from those of the first embodiment. In the device of the second comparative example, the resonant frequencies of the six vibration modes are not aggregated into a single frequency. In the device of the second comparative example, the resonant frequencies of the six vibration modes are 25 Hz, 33 Hz, 47 Hz, etc.

In the device of the first comparative example, the resonant frequencies of the six vibration modes are aggregated into the predetermined single frequency fa. Specifically, this predetermined frequency fa is 17 Hz. The vibration transmissibility can be lowered at frequencies higher than the resonant frequencies. Therefore, as shown in FIG. 21, when the vibration transmissibilities in a frequency range higher than 17 Hz are compared, the vibration transmissibility of the device of the first comparative example is lower than the vibration transmissibility of the device of the second comparative example. Therefore, the device of the first comparative example can improve the vibration isolation effect in the frequency range higher than the aggregated resonant frequency in comparison to the device of the second comparative example.

By the way, the resonant frequencies of the device of the second comparative example may be lowered to increase the vibration isolation effect in the targeted frequency range. However, in order to lower the resonant frequencies, it is necessary to reduce the rigidity of the elastic member. If the rigidity of the elastic member is reduced, the displacement of the elastic member increases. Thereby, the durability of the elastic member decreases.

In contrast, the predetermined frequency fa of the device of the first comparative example is 17 Hz that is close to 20 Hz which is the resonant frequency with the highest vibration transmissibility among the resonant frequencies of the device of the second comparative example. The device of the first comparative example can improve the vibration isolation effect in the targeted frequency range without significantly lowering the resonant frequencies. Therefore, a reduction in the rigidity of the elastic member can be limited, and a decrease in the durability of the elastic member can be limited.

However, as shown in FIG. 21, the vibration transmissibility T1 of the device of the first comparative example at the frequency of 17 Hz is higher than the vibration transmissibility T2 of the device of the second comparative example at or around 20 Hz frequency. The inventors of the present application have found that the device of the first comparative example decreases the vibration isolation effect in the frequency range of the aggregated resonant frequency in comparison to the device of the second comparative example.

In view of the above point, according to the present embodiment, in order to improve the vibration isolation effect in the frequency range of the aggregated resonant frequency, a vibration-isolating rubber, which includes the silicone rubber and the CNTs, is used as each of the vibration-isolating rubbers 30a, 30b, 30c, 30d. The CNT mixing ratio is larger than 0 parts by mass and is equal to or smaller than 3 parts by mass per 100 parts by mass of the silicone rubber. It should be noted that “parts by mass” indicates a percentage of the additive relative to the mass of the rubber and is also indicated by “phr”. Here, “phr” is an abbreviation for “parts per hundred of rubber”.

The reason for using the silicone rubber as the rubber material is that the silicone rubber has the high damping performance and the low temperature dependence of elastic modulus in the entire service temperature range. The service temperature range is the temperature range of the environment in which the compressor 10 is used. Specifically, the service temperature range is from −20° C. to 80° C. One reason why the CNTs are added to the silicone rubber is to increase the fatigue strength of the silicone rubber. Furthermore, another reason why the CNTs are added to the silicone rubber is that the CNTs can further enhance the damping performance of the silicone rubber. (Reason for setting the CNT mixing ratio to a value larger than 0 parts by mass per 100 parts by mass of the silicone rubber)

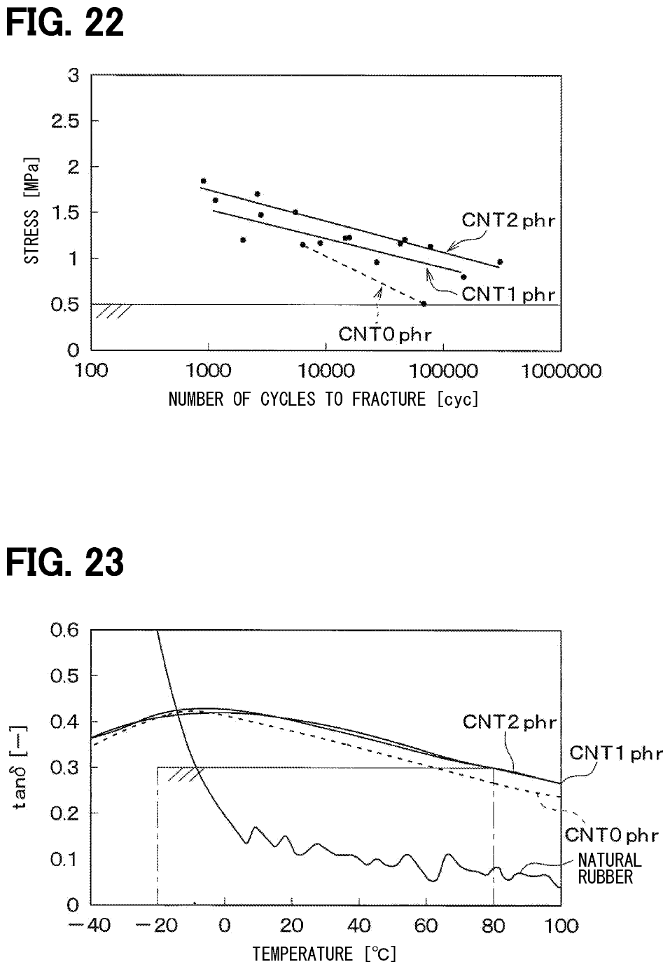

FIG. 22 shows results of a cyclic fatigue evaluation test for a silicone rubber having a CNT mixing ratio of 0 phr, a silicone rubber having a CNT mixing ratio of 1 phr and a silicone rubber having a CNT mixing ratio of 2 phr. The silicone rubber, the CNTs, the device and the test condition used for the test are as follows.

Silicone rubber: “KE-5540-U” of Shin-Etsu Chemical Co., Ltd.

CNT: “NC7000” of Nanocyl S.A.

Device: Dynamic fatigue tester

Sample piece form: Dumbbell type 3 as specified in JIS K6251

Maximum amplitude distortion: 50 to 250%

As shown in FIG. 22, it can be inferred that when the number of cycles to fracture is 100,000, the silicone rubber having the CNT mixing ratio of 0 phr (i.e., CNT0 phr in FIG. 22) does not satisfy the rupture stress σ≥0.5 MPa, which is a cyclic fatigue condition required in the actual use. However, when the number of cycles to fracture is 100,000, the silicone rubber having the CNT mixing ratio of 1 phr and the silicone rubber having the CNT mixing ratio of 2 phr (i.e., CNT1 phr and CNT2 phr in FIG. 22) satisfy the rupture stress a 0.5 MPa. The cyclic fatigue condition required in the actual use is a condition required for each of the vibration-isolating rubbers 30a, 30b, 30c, 30d in the state where the compressor 10 is mounted on the vehicle. The rupture stress σ≥0.5 MPa is calculated based on the following equation and the condition of actual use. In this calculation, the shape of the cross-section of the vibration-isolating rubber is square.

σ=MG/(a₁²·n)×S=0.5 MPa

σ: Rupture stress (i.e., a maximum stress applied to the vibration-isolating rubber)

M: Mass of the compressor

G: Maximum vibration

a₁: Length of one side of the square that is the shape of the cross-section of the vibration-isolating rubber

n: number of the rubbers

S: Safety rate

M=6 kg, G=40 m/sec², a₁=15 mm, n=4, S=2

As shown in FIG. 22, the rupture stress a of the silicone rubber having the CNT mixing ratio of 1 phr and the rupture stress a of the silicone rubber having the CNT mixing ratio of 2 phr are increased in comparison to the silicone rubber having the CNT mixing ratio of 0 phr. Based on this result, it can be inferred that the rupture stress a increases even in the silicone rubber having the CNT mixing ratio larger than 0 phr and smaller than 1 phr in comparison to the silicone rubber having the CNT mixing ratio of 0 phr. Thus, the addition of the CNTs to the silicone rubber can increase the fatigue strength of the silicone rubber. The addition of the CNTs to the silicone rubber may meet the cyclic fatigue condition required in the actual use.

FIG. 23 shows results of a viscoelasticity evaluation test for the silicone rubber having the CNT mixing ratio of 0 phr, the silicone rubber having the CNT mixing ratio of 1 phr and the silicone rubber having the CNT mixing ratio of 2 phr. The silicone rubber, the CNTs, the device and the test condition used for this test are as follows.

Silicone rubber: “KE-5540-U” of Shin-Etsu Chemical Co., Ltd.

CNT: “NC7000” of Nanocyl S.A.

Device: Dynamic viscoelasticity tester

Sample piece form: Strip having a width of 2 mm, a thickness of 1 mm and a length of 10 mm

Distortion: 1%

Frequency: 10 Hz

As shown in FIG. 23, a damping coefficient tan δ of the natural rubber decreases from about 0.6 to about 0.1 as the temperature decreases in a temperature range from −20° C. to 20° C. The damping coefficient tan δ of the natural rubber is about 0.1 in a temperature range from 20° C. to 80° C. Thus, the natural rubber has the low damping coefficient tan δ in the part of the service temperature range and has the high temperature dependence of the damping performance in the entire service temperature range.

In contrast, the damping coefficient tan δ of the silicone rubber having the CNT mixing ratio of 1 phr and the damping coefficient tan δ of the silicone rubber having the CNT mixing ratio of 2 phr are equal to or larger than 0.3 in the temperature range from −20° C. to 80° C.

The damping coefficient tan δ of the silicone rubber having the CNT mixing ratio of 0 phr is larger than 0.25 in the temperature range from −20° C. to 80° C. Therefore, it is inferred that the damping coefficient tan δ is larger than 0.25 in the temperature range from −20° C. to 80° C. even when the CNT mixing ratio is larger than 0 phr and smaller than 1 phr.

Thus, the silicone rubber, to which the CNTs are added, has the high damping performance and the low temperature dependence of damping performance in the entire service temperature range.

Based on the above, the CNT mixing ratio should be larger than 0 parts by mass per 100 parts by mass of the silicone rubber.

(Reason for setting the CNT mixing ratio to a value smaller than 3 parts by mass per 100 parts by mass of the silicone rubber)

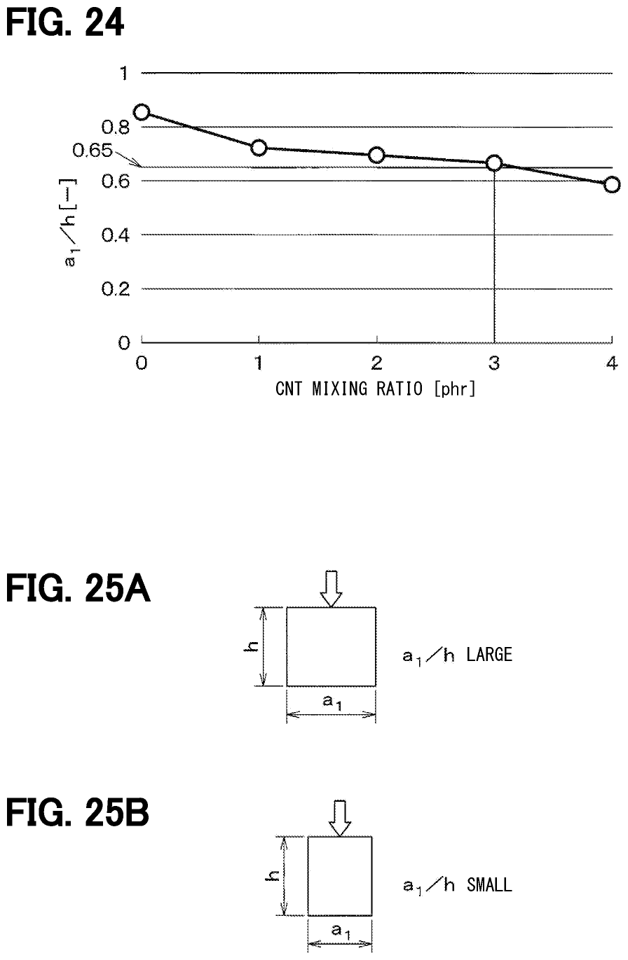

FIG. 24 shows a relationship between the CNT mixing ratio and a geometrical ratio a₁/h of the vibration-isolating rubber. As shown in FIGS. 25A and 25B, the geometrical ratio a₁/h is a ratio of the length a₁ of the one side of the cross-section of the vibration-isolating rubber relative to the height h of the vibration-isolating rubber. The vibration-isolating rubber is shaped in a form of square column which has a square cross-section. If the height h is kept the same, the length a₁ of the one side of the cross-section is reduced when the geometrical ratio a₁/h is reduced. In other words, when the geometrical ratio a₁/h is reduced, the cross-section of the vibration-isolating rubber is reduced.

The geometrical ratio a₁/h of the vibration-isolating rubber having the CNT mixing ratio of 0 phr is determined based on the required rigidity of the vibration-isolating rubber that is required to coincide the resonant frequencies with each other. The rigidity of the other vibration-isolating rubbers respectively having the CNT mixing ratio larger than 0 phr is set to be the same as the rigidity of the vibration-isolating rubber having the CNT mixing ratio of 0 phr. Therefore, as shown in FIG. 24, when the CNT mixing ratio is increased, the geometrical ratio a₁/h needs to be reduced. This is due to a reason that when the CNT mixing ratio relative to the silicone rubber is increased, the hardness of the vibration-isolating rubber is increased.

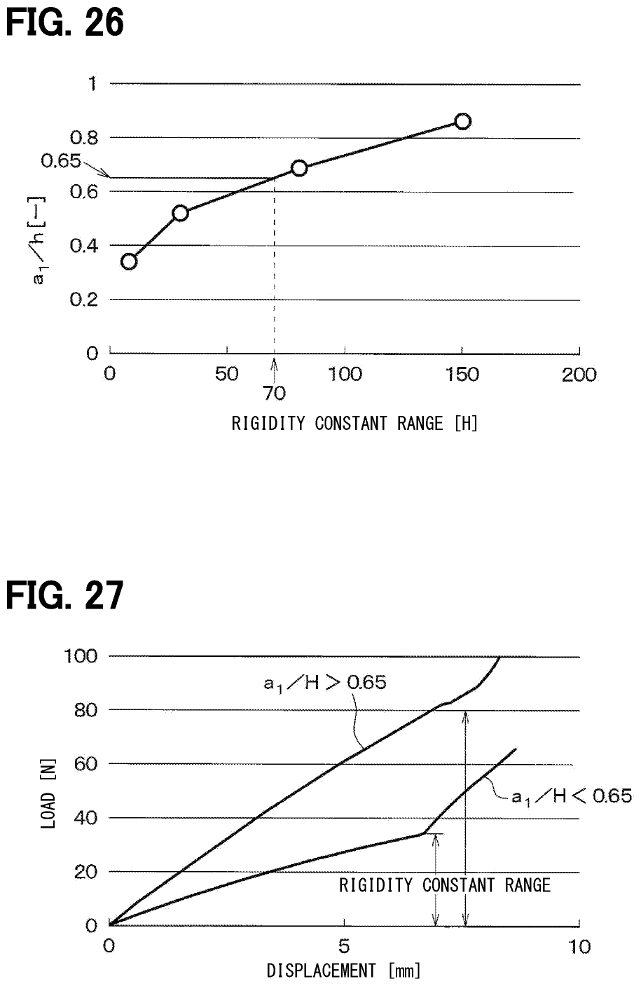

FIG. 26 shows a relationship between the geometrical ratio and a maximum load in a rigidity constant range. The rigidity constant range is a range of load in which the rigidity of the vibration-isolating rubber becomes constant at the time of deforming the vibration-isolating rubber through application of the load to the vibration-isolating rubber. In other words, the rigidity constant range is the range of load in which a slope of a graph indicating a relationship between the load and the displacement becomes constant, as indicated in FIG. 27.

In the state where the compressor 10 is mounted on the vehicle, a maximum value of the load, which is applied from the compressor 10 or the vehicle body 20 to the vibration-isolating rubbers 30a, 30b, 30c, 30d, is 70 N. A range, in which the load is larger than 0 and is equal to or smaller than 70 N, is a practical service range. As shown in FIG. 26, a value of the geometrical ratio a₁/h, at which the rigidity becomes constant at the maximum load of 70 N, is 0.65. Therefore, the geometrical ratio a₁/h needs to be equal to or larger than 0.65. As shown in FIG. 27, in a case where the geometrical ratio a₁/h is larger than 0.65, the rigidity is constant even when the load is increased beyond 70 N. However, in a case where the geometrical ratio a₁/h is smaller than 0.65, the rigidity changes when the load is equal to or smaller than 70 N. In the case where the rigidity is constant, two goals, i.e., the durability and the vibration-isolating performance of the vibration-isolating rubber can be both achieved by aggregating the resonant frequencies. However, in the case where the rigidity changes, these two goals cannot be achieved.

As shown in FIG. 24, when the CNT mixing ratio is increased beyond 3 phr, the geometrical ratio a₁/h becomes equal to or smaller than 0.65. Therefore, in the practical service range, the CNT mixing ratio, which can achieve the same rigidity as the rigidity of the vibration-isolating rubber having the CNT mixing ratio of 0 phr, is equal to or smaller than 3 phr.

Thus, the CNT mixing ratio needs to be smaller than 3 parts by mass per 100 parts by mass of the silicone rubber.

Like the device of the first comparative example, in the vibration-isolating device of the present embodiment, the resonant frequencies of the six vibration modes are aggregated into the predetermined single frequency fa, i.e., are respectively set to the predetermined single frequency fa. This predetermined frequency fa is 17 Hz. Therefore, as indicated in FIG. 21, even in the vibration-isolating device of the present embodiment, like the device of the first comparative example, the vibration transmissibility in the frequency range higher than 17 Hz can be reduced in comparison to the device of the second comparative example. In other words, the vibration isolation effect in the frequency range higher than the aggregated resonant frequency can be improved in comparison to the device of the second comparative example. Furthermore, like the device of the first comparative example, the vibration-isolating device of the present embodiment can improve the vibration isolation effect in the targeted frequency range without significantly lowering the resonant frequencies in comparison to the device of the second comparative example. Therefore, a reduction in the rigidity of the elastic member can be limited, and a decrease in the durability of the elastic member can be limited.

Furthermore, in the device of the present embodiment, each of the vibration-isolating rubbers 30a, 30b, 30c, 30d includes: 100 parts by mass of the silicone rubber; and larger than 0 parts by mass and equal to or smaller than 3 parts by mass of the CNTs.

Here, the vibration-isolating rubber of the device of the first comparative example is made of the natural rubber. As shown in FIG. 23, in the temperature range from −10° C. to 80° C., the damping coefficient tan δ of the silicone rubber having the CNT mixing ratio of 0 parts by mass (i.e., 0 phr), the damping coefficient tan δ of the silicone rubber having the CNT mixing ratio of 1 parts by mass (i.e., 1 phr), and the damping coefficient tan δ of the silicone rubber having the CNT mixing ratio of 2 parts by mass (i.e., 2 phr) are larger than the damping coefficient tan δ of the natural rubber.

Therefore, in the temperature range from −10° C. to 80° C., the device of the present embodiment can reduce the vibration transmissibility at the frequency of 17 Hz in comparison to the vibration transmissibility of the device of the first comparative example at the frequency of 17 Hz.

Furthermore, as shown in FIG. 23, the damping coefficient tan δ of the silicone rubber having the CNT mixing ratio, which is equal to or larger than 1 parts by mass and is equal to or smaller than 2 parts by mass, is equal to or larger than 0.3 in the entire service temperature range. In the device of the present embodiment, it is preferred that the CNT mixing ratio is equal to or larger than 1 parts by mass and is equal to or smaller than 2 parts by mass. Therefore, as shown in FIG. 21, the vibration transmissibility at the frequency of 17 Hz can be reduced from the vibration transmissibility T1 of the first comparative example to a vibration transmissibility T3 which is slightly lower than the vibration transmissibility T2 of the second comparative example. Here, T1 shown in FIG. 21 is the vibration transmissibility when the damping coefficient tan δ is 0.1. Furthermore, T3 in FIG. 21 is the vibration transmissibility when the damping coefficient tan δ is 0.3. As discussed above, the vibration isolation effect at the resonant frequencies can be increased to a level equivalent to that of the device of the second comparative example.

### Second Embodiment

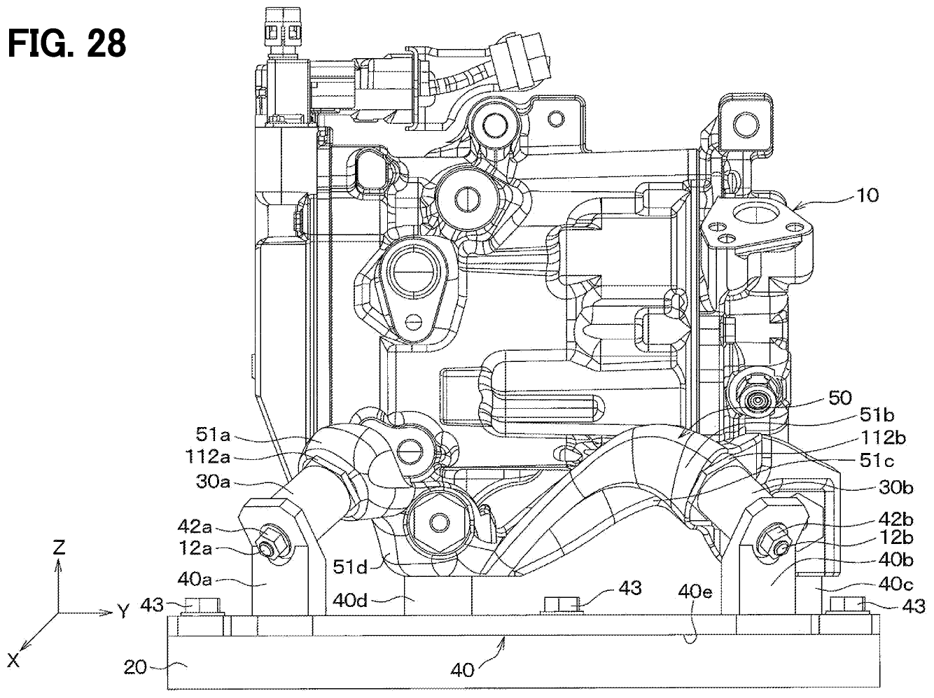

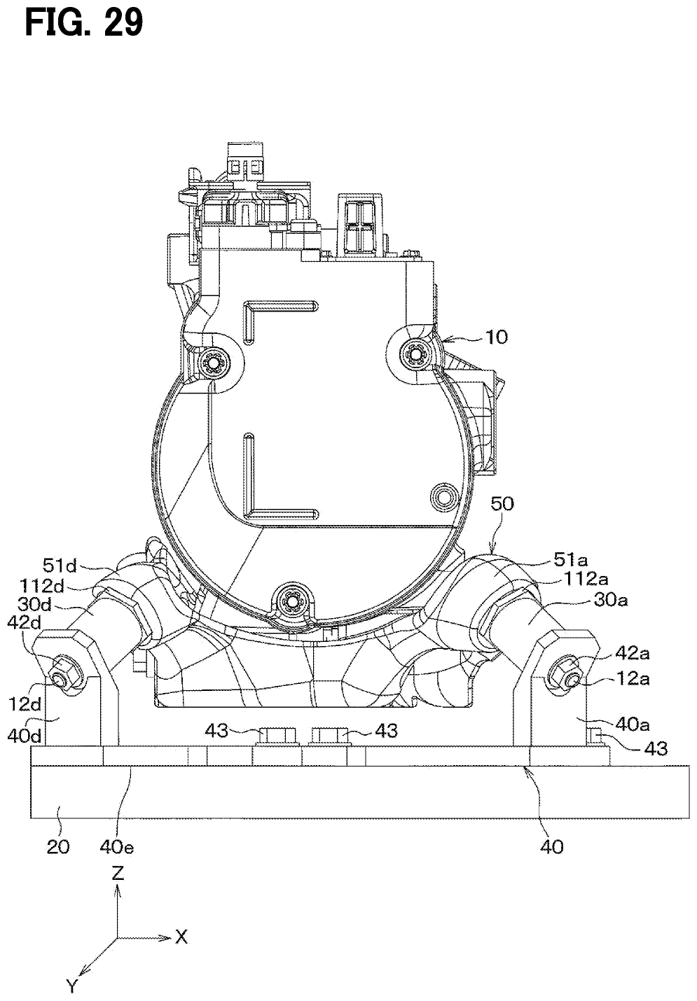

In the first embodiment, each of the vibration-isolating rubbers 30a, 30b, 30c, 30d is placed between the corresponding leg 11a, 11b, 11c, 11d of the compressor 10 and the corresponding leg 40a, 40b, 40c, 40d of the support member 40. In contrast, according to the present embodiment, as shown in FIGS. 28 and 29, one upper support member 50 is placed on a lower side of the compressor 10. The vibration-isolating rubbers 30a, 30b, 30c, 30d are placed between the upper support member 50 and the lower support member 40. The lower support member 40 of the present embodiment corresponds to the support member 40 of the first embodiment. Furthermore, the upper support member 50 corresponds to a primary support member. The lower support member 40 corresponds to a secondary support member.

The structure of the vibration-isolating device of the present embodiment is the same as that of the vibration-isolating device of the first embodiment except that it has the upper support member 50. Hereinafter, the discussion is focused mainly on the upper support member 50 and its related parts of the vibration-isolating device of the present embodiment.

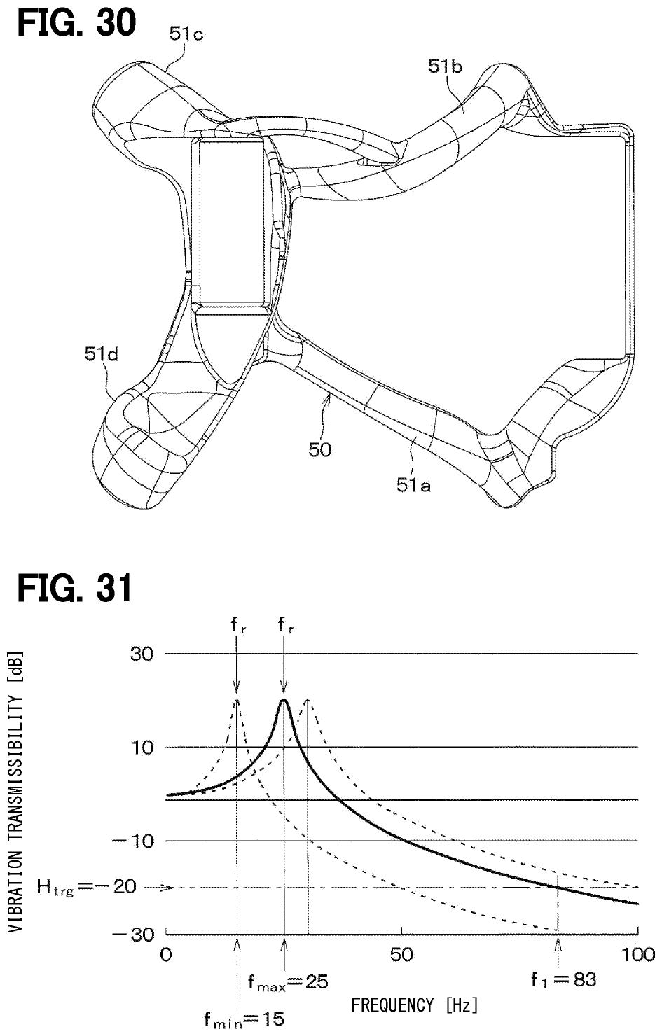

The upper support member 50 is placed on the lower side of the compressor 10 in the vertical direction. The upper support member 50 is fixed to the compressor 10 by fasteners, such as bolts. As shown in FIG. 30, the upper support member 50 is a one-piece component that includes four legs 51a, 51b, 51c, 51d. Alternatively, the four legs 51a, 51b, 51c, 51dd may be formed as four separate bodies, respectively. In such a case, the four legs 51a, 51b, 51c, 51d correspond to a plurality of primary support members.

As shown in FIGS. 28 and 29, the vibration-isolating rubber 30a is fixed to a portion of the upper support member 50 which is located on a side that is opposite to the compressor 10. Specifically, the threaded fastener 112a, which is located on one axial side of the vibration-isolating rubber 30a, is threadably fastened to a female-threaded hole of the leg 51a of the upper support member 50. Furthermore, the nut 42a is threadably fastened to the threaded fastener 12a, which is located on the other axial side of the vibration-isolating rubber 30a, in the state where the threaded fastener 12a is inserted through the through-hole of the leg 40a of the lower support member 40.

The vibration-isolating rubber 30b is fixed to a portion of the upper support member 50 which is located on the side that is opposite to the compressor 10. Specifically, the threaded fastener 112b, which is located on one axial side of the vibration-isolating rubber 30b, is threadably fastened to a female-threaded hole of the leg 51b of the upper support member 50. Furthermore, the nut 42b is threadably fastened to the threaded fastener 12b, which is located on the other axial side of the vibration-isolating rubber 30b, in the state where the threaded fastener 12b is inserted through the through-hole of the leg 40b of the lower support member 40.

The vibration-isolating rubber 30d is fixed to a portion of the upper support member 50 which is located on the side that is opposite to the compressor 10. Specifically, the threaded fastener 112d, which is located on one axial side of the vibration-isolating rubber 30d, is threadably fastened to a female-threaded hole of the leg 51d of the upper support member 50. Furthermore, the nut 42d is threadably fastened to the threaded fastener 12d, which is located on the other axial side of the vibration-isolating rubber 30d, in the state where the threaded fastener 12d is inserted through the through-hole of the leg 40d of the lower support member 40.

Although not shown in FIGS. 28 and 29, the vibration-isolating rubber 30c shown in FIG. 3A is fixed to a portion of the upper support member 50 which is located on the side that is opposite to the compressor 10. Specifically, the threaded fastener 112c, which is located on one axial side of the vibration-isolating rubber 30c shown in FIG. 3A, is threadably fastened to a female-threaded hole of the leg 51c of the upper support member 50. Furthermore, the nut is threadably fastened to the threaded fastener 12c, which is located on the other axial side of the vibration-isolating rubber 30c shown in FIG. 3A, in the state where the threaded fastener 12c is inserted through the through-hole of the leg 40c of the lower support member 40.

As discussed above, the compressor 10 is supported by the lower support member 40 through the vibration-isolating rubbers 30a, 30b, 30c, 30d.

In the present embodiment, the center of gravity G of the object, which includes the compressor 10 and the upper support member 50, coincides with the elastic center Sa of this object. Therefore, the translational vibrations and the swing vibrations are generated independently in the six directions.

Therefore, like in the first embodiment, the resonant frequencies fx, fy, fz, fφ, fΨ, fθ of the six vibration modes are respectively expressed by the equations 6-11 by using p, q, R of the equation 5, the mounting position (a, b, c) and the rigidities k₁, k₂. The resonant frequencies fx, fy, fz, fφ, fΨ, fθ of the six vibration modes are the resonant frequencies of the structure at the time of vibrating the compressor 10 in the six degrees of freedom. This structure includes the compressor 10, the upper support member 50, the vibration-isolating rubbers 30a, 30b, 30c, 30d and the lower support member 40.

Here, m of each of the equation 6, the equation 7 and the equation 8 is a mass of the object, which includes the compressor 10 and the upper support member 50. Furthermore, lx of the equation 9 is an inertia moment in the X direction at the object, which includes the compressor 10 and the upper support member 50. Also, Iy of the equation 10 is an inertia moment in the Y direction at the object, which includes the compressor 10 and the upper support member 50. Additionally, Iz of the equation 11 is an inertia moment in the Z direction at the object, which includes the compressor 10 and the upper support member 50.

Like in the first embodiment, the compressor 10, the upper support member 50 and the vibration-isolating rubbers 30a, 30b, 30c, 30d are set, i.e., are configured such that the resonant frequencies fx, fy, fz, fφ, fΨ, fθ of the six vibration modes are aggregated into the predetermined single frequency fa, i.e., are respectively set to the predetermined single frequency fa. In other words, the mass of the compressor 10, the mass of the upper support member 50 and the rigidity and the position of the respective vibration-isolating rubbers 30a, 30b, 30c, 30d are set such that the resonant frequencies fx, fy, fz, fφ, fΨ, fθ of the six vibration modes are aggregated into the predetermined single frequency fa.

Furthermore, like in the first embodiment, each of the vibration-isolating rubbers 30a, 30b, 30c, 30d includes: 100 parts by mass of the silicone rubber; and larger than 0 parts by mass and equal to or smaller than 3 parts by mass of the CNTs.

Thus, the vibration-isolating device of the present embodiment can also achieve advantages which are similar to those of the vibration-isolating device of the first embodiment.

### Third Embodiment

In the first and second embodiments, the resonant frequencies are set to match 17 Hz in order to achieve both the durability and the vibration isolation effect of the vibration-isolating rubbers. However, in the first and second embodiments, as discussed below, the resonant frequencies may be set to match another predetermined frequency which is other than 17 Hz.

A strain ε of the vibration-isolating rubber at the time of vibrating the compressor 10 by a load F is indicated by an equation 16. Here, F of equation 16 is indicated by an equation 17. Furthermore, the resonant frequency is indicated by an equation 18.

$$\begin{matrix}ɛ = \frac{F}{k L} ≦ {ɛ}_{t r g} & [ Equation 16 ] \\ F = \frac{m G}{n} & [ Equation 17 ] \\ {f}_{r} = \frac{1}{2 π} \sqrt{\frac{k}{m}} & [ Equation 18 ]\end{matrix}$$

ε: Strain of the vibration-isolating rubber

F: Force applied to the compressor

k: Rigidity of the vibration-isolating rubber

L: Length of the vibration-isolating rubber

ε_{trg}: Strain endurance limit

G: Acceleration

n: Number of the vibration-isolating rubbers

Here, m of the equations is the mass of the compressor 10 in the first embodiment and is the mass of the object, which includes the compressor 10 and the upper support member 50, in the second embodiment.

As in the equation 16, in order to ensure the durability of the vibration-isolating rubbers, the strain ε is set to be equal to or smaller than ε_{trg}. A minimum value of the rigidity k, which is required in this case, can be obtained by the equation 16 and the equation 17. Furthermore, by using the obtained minimum value of the rigidity k and the equation 18, a minimum frequency fₘᵢₙ of the resonant frequency fᵣ required in this case can be obtained.

Specifically, fₘᵢₙ=15 Hz is obtained in a case of m=6.0 kg, n=4, G=40 m/sec², ε_{trg}=30%, and L=30 mm. Therefore, in order to ensure the durability of the vibration-isolating rubbers, the resonant frequency needs to be equal to or higher than 15 Hz.

Furthermore, a vibration transmissibility H(f) at the frequency f is obtained by an equation 19. The equation 19 is an equation when the resonant frequencies of the six vibration modes are aggregated into the predetermined single frequency, i.e., are respectively set to the predetermined single frequency.

$$H ( f ) = \frac{\sqrt{1 + {tan}^{2} δ}}{\sqrt{{( 1 - {( \frac{f}{{f}_{r}} )}^{2} )}^{2} + {tan}^{2} δ}} \qquad [ Equation 19 ]$$

fᵣ: Resonant frequency

tan δ: Damping rate of the vibration-isolating rubber

As shown in FIG. 31, in order to keep the vibration transmissibility at the frequency f₁, (the frequency f₁ being higher than the resonant frequency fᵣ) below or equal to a target value H_{trg}, it is necessary to keep the resonant frequency fᵣ below or equal to fₘₐₓ. In the actual use, the vibration transmissibility at f₁=83 Hz must be kept below or equal to H_{trg}=−20 dB. According to the equation 19, the resonant frequency fᵣ required in this case is less than or equal to 25 Hz.

Therefore, in order to achieve both the durability and the vibration isolation effect of the vibration-isolating rubbers, the resonant frequencies fx, fy, fz, fφ, fΨ, fθ of the six vibration modes should be respectively set to match a predetermined frequency which is other than 17 Hz and is within the range of 15 Hz to 25 Hz. By setting in the above-described manner, advantages, which are similar to those of the first embodiment, can be achieved.

### Other Embodiments

(1) In each of the above embodiments, the resonant frequencies fx, fy, fz, fφ, fΨ, fθ of the six vibration modes are aggregated into the predetermined single frequency fa, i.e., are respectively set to the predetermined single frequency fa. However, the resonant frequencies fx, fy, fz, fφ, fΨ, fθ of the six vibration modes may not be aggregated into the predetermined single frequency fa. The resonant frequencies fx, fy, fz, fφ, fΨ, fθ of the six vibration modes may be aggregated in, i.e., may be respectively set in a range of 10 Hz that is from 15 Hz to 25 Hz described in the third embodiment. In other words, a difference between a maximum value and a minimum value of the resonant frequencies fx, fy, fz, fφ, fΨ, fθ of the six vibration modes should be equal to or less than 10 Hz. Even in this case, it is assumed that advantages, which are similar to those of the first embodiment, are achieved.

(2) In each of the above embodiments, the four vibration-isolating rubbers 30a, 30b, 30c, 30d are used. However, the number of the vibration-isolating rubbers 30a, 30b, 30c, 30d may be other than four. Even in such a case, the resonant frequencies fx, fy, fz, fφ, fΨ, fθ of the six vibration modes should match the predetermined single frequency, or the difference between the maximum value and the minimum value of the resonant frequencies fx, fy, fz, fφ, fΨ, fθ of the six vibration modes should be equal to or less than 10 Hz. In short, the present disclosure requires that at least one vibration-isolating rubber be used.

The number of the legs of the support member 40 of the first embodiment should be changed as the number of the vibration-isolating rubbers is changed. Similarly, the number of the legs of the lower support member 40 and the number of the legs of the upper support member 50 of the second embodiment should be changed as the number of the vibration-isolating rubbers is changed.

(3) In each of the above embodiments, the center of gravity G and the elastic center Sa coincide with each other. However, the center of gravity G and the elastic center Sa may not coincide with each other. Even in such a case, the resonant frequencies fx, fy, fz, fφ, fΨ, fθ of the six vibration modes should match the predetermined single frequency, or the difference between the maximum value and the minimum value of the resonant frequencies fx, fy, fz, fφ, fΨ, fθ of the six vibration modes should be equal to or less than 10 Hz.

Even in the case where the center of gravity G and the elastic center Sa do not coincide with each other, it is preferred that the four vibration-isolating rubbers 30a, 30b, 30c, 30d are set, i.e., are configured such that the center of gravity of the compressor 10 is located within the virtual region formed by combing the first pentahedron and the second pentahedron shown in FIG. 4. The first pentahedron and the second pentahedron shown in FIG. 4 are determined as follows. The axes Xa, Xb, Xc, Xd of the four vibration-isolating rubbers 30a, 30b, 30c, 30d are now defined as primary lines Xa, Xb, Xc, Xd. An intersecting point, at which a corresponding one of the primary lines Xa, Xb, Xc, Xd and a corresponding one of the end surfaces 31a, 31b, 31c, 31d intersect with each other, is defined as the reference point A, B, C, D. The virtual lines Ya, Yb, Yc, Yd, which respectively intersect the axes Xa, Xb, Xc, Xd at the reference points A, B, C, D, will be defined as secondary lines Ya, Yb, Yc, Yd. The vibration-isolating rubbers 30a, 30b, 30c, 30d are set such that the primary lines Xa, Xb, Xc, Xd intersect with each other at the point P, and the secondary lines Ya, Yb, Yc, Yd intersect at the point Q. At this time, the imaginary first pentahedron is formed by the reference points A, B, C, D and the point P, which serve as vertices of the imaginary first pentahedron. The imaginary second pentahedron is formed by the reference points A, B, C, D and the point Q, which serve as vertices of the imaginary second pentahedron.

Here, it is desirable that the center of gravity G and the elastic center Sa coincide with each other. In this case, the resonant frequencies fx, fy, fz, fφ, fΨ, fθ of the six vibration modes are indicated by the equations 6-11 that are more simplified than the case where the center of gravity G and the elastic center Sa do not coincide with each other. Therefore, the resonant frequencies fx, fy, fz, fφ, fΨ, fθ can coincide with each other more easily in comparison to the case where the center of gravity G and the elastic center Sa do not coincide with each other.

In order to coincide the center of gravity G and the elastic center Sa with each other, the compressor 10 and the four vibration-isolating rubbers 30a, 30b, 30c, 30d are specifically set as follows. The shear rigidity of each of the four vibration-isolating rubbers 30a, 30b, 30c, 30d in the axial direction is identically set. In each of the vibration-isolating rubbers 30a, 30b, 30c, 30d, the shear rigidity in a first direction perpendicular to the axial direction of the vibration-isolating rubber 30a, 30b, 30c, 30d is the same as the shear rigidity in a second direction perpendicular to both the axial direction of the vibration-isolating rubber 30a, 30b, 30c, 30d and the first direction. In each of the four elastic members, the shear rigidity in the axial direction is defined as k₁, and the shear rigidity in each of the first direction and the second direction is defined as k₂. When the center of gravity of the compressor 10 is defined as the center of gravity G, the line segment Sb, which connects between the point P and the point Q, includes the center of gravity G. The distance measured between the center of gravity G and the point Q along the line segment Sb is defined as Z1, and the distance measured between the center of gravity G and the point P is defined as Z2. In such a case, Z1/Z2 coincides with k₁/k₂. Therefore, the center of gravity G and the elastic center Sa coincide with each other.

(4) In the first and second embodiments, the center of gravity G and the elastic center Sa coincide with each other. Furthermore, as shown in FIGS. 7 to 14, the setting angle of each of the axes Xa, Xb, Xc, Xd is set to be 45 degrees. In this way, the resonant frequencies fx, fy, fz can be expressed by the same equation. However, as long as the resonant frequencies fx, fy, fz, fφ, fΨ, fθ of the six vibration modes are aggregated into the predetermined single frequency fa, the setting angle of each of the axes Xa, Xb, Xc, Xd may not be 45 degrees.

(5) In each of the above embodiments, the vibration-isolating rubbers are respectively shaped in the circular column having the circular cross-section or the square column having the square cross-section. However, the vibration-isolating rubbers may be shaped in another form. The other form of the vibration-isolating rubbers may be a column having a polygonal cross-section.

(6) In each of the above embodiments, the compressor 10 is placed on the upper side of the vehicle body 20. However, the compressor 10 may be placed on the lower side of the vehicle body 20.

(7) In each of the above embodiments, the compressor 10 is used as the vibration source. However, another device, which is other than the compressor 10, may be used as the vibration source. The transmission-receiving member, to which the vibrations are transmitted from the vibration source, may be another object that is other than the vehicle body 20. The transmission-receiving member can be a member of a moving object such as a train, an airplane, etc. or a non-moving object.

(8) The present disclosure should not be limited to the embodiments described above, but may be modified as appropriate, and encompasses various variations and variations within the equivalent range. The above embodiments are not unrelated to each other, and can be combined as appropriate, unless the combination is clearly impossible. In each of the above embodiments, it is needless to say that the elements constituting the embodiment are not necessarily essential, unless otherwise clearly indicated as essential or in principle considered to be clearly essential. In each of the above embodiments, when a numerical value such as the number, numerical value, amount, range or the like of the constituent elements of the exemplary embodiment is mentioned, the present disclosure should not be limited to such a numerical value unless it is clearly stated that it is essential and/or it is required in principle. In each of the above embodiments, when referring to the material, the shape, the positional relationship or the like of the components, the present disclosure should not be limited to such a material, shape, positional relationship or the like unless it is clearly stated that it is essential and/or it is required in principle.

### CONCLUSION

According to a first aspect indicated in a portion or a whole of each of the above embodiments, there is provided a vibration-isolating device configured to limit transmission of vibrations from a vibration source to a transmission-receiving member. The vibration-isolating device includes: the vibration source that is configured to generate the vibrations; and at least one vibration-isolating rubber that is fixed to the vibration source. The vibration source is supported by at least one support member that is fixed to the transmission-receiving member through the at least one vibration-isolating rubber. The vibration source and the at least one vibration-isolating rubber are configured such that a difference between a maximum value and a minimum value of resonant frequencies of a structure, which includes the vibration source, the at least one vibration-isolating rubber and the at least one support member, is equal to or smaller than 10 Hz when the vibration source is vibrated in six degrees of freedom. The at least one vibration-isolating rubber includes: 100 parts by mass of silicone rubber; and larger than 0 parts by mass and equal to or smaller than 3 parts by mass of carbon nanotubes.

Furthermore, according to a second aspect, there is provided a vibration-isolating device configured to limit transmission of vibrations from a vibration source to a transmission-receiving member. The vibration-isolating device includes: the vibration source that is configured to generate the vibrations; at least one primary support member that is fixed to the vibration source and supports the vibration source; and at least one vibration-isolating rubber that is fixed to a portion of the at least one primary support member which is located on a side that is opposite to the vibration source. The vibration source is supported by at least one secondary support member that is fixed to the transmission-receiving member through the at least one vibration-isolating rubber. The vibration source, the at least one primary support member and the at least one vibration-isolating rubber are configured such that a difference between a maximum value and a minimum value of resonant frequencies of a structure, which includes the vibration source, the at least one primary support member, the at least one vibration-isolating rubber and the at least one secondary support member, is equal to or smaller than 10 Hz when the vibration source is vibrated in six degrees of freedom. The at least one vibration-isolating rubber includes: 100 parts by mass of silicone rubber; and larger than 0 parts by mass and equal to or smaller than 3 parts by mass of carbon nanotubes.

A mixing ratio of the carbon nanotubes in the at least one vibration-isolating rubber is equal to or larger than 1 parts by mass and is equal to or smaller than 2 parts by mass per 100 parts by mass of the silicone rubber. Thereby, the damping coefficient tan δ of the silicone rubber can be equal to or larger than 0.3 in the temperature range of −20° C. to 80° C. Therefore, the vibration transmissibility at the frequency range of the aggregated resonant frequency(ies) can be further reduced, and thereby the vibration isolation effect can be further improved.

1. A vibration-isolating device configured to limit transmission of vibrations from a vibration source to a transmission-receiving member, the vibration-isolating device comprising:
the vibration source that is configured to generate the vibrations; and
at least one vibration-isolating rubber that is fixed to the vibration source, wherein:
the vibration source is supported by at least one support member that is fixed to the transmission-receiving member through the at least one vibration-isolating rubber;
the vibration source and the at least one vibration-isolating rubber are configured such that a difference between a maximum value and a minimum value of resonant frequencies of a structure, which includes the vibration source, the at least one vibration-isolating rubber and the at least one support member, is equal to or smaller than 10 Hz when the vibration source is vibrated in six degrees of freedom; and
the at least one vibration-isolating rubber includes:
100 parts by mass of silicone rubber; and
larger than 0 parts by mass and equal to or smaller than 3 parts by mass of carbon nanotubes.

2. The vibration-isolating device according to claim 1, wherein a mixing ratio of the carbon nanotubes in the at least one vibration-isolating rubber is equal to or larger than 1 parts by mass and is equal to or smaller than 2 parts by mass per 100 parts by mass of the silicone rubber.

3. A vibration-isolating device configured to limit transmission of vibrations from a vibration source to a transmission-receiving member, the vibration-isolating device comprising:
the vibration source that is configured to generate the vibrations;
at least one primary support member that is fixed to the vibration source and supports the vibration source; and
at least one vibration-isolating rubber that is fixed to a portion of the at least one primary support member which is located on a side that is opposite to the vibration source, wherein:
the vibration source is supported by at least one secondary support member that is fixed to the transmission-receiving member through the at least one vibration-isolating rubber;
the vibration source, the at least one primary support member and the at least one vibration-isolating rubber are configured such that a difference between a maximum value and a minimum value of resonant frequencies of a structure, which includes the vibration source, the at least one primary support member, the at least one vibration-isolating rubber and the at least one secondary support member, is equal to or smaller than 10 Hz when the vibration source is vibrated in six degrees of freedom; and
the at least one vibration-isolating rubber includes:
100 parts by mass of silicone rubber; and
larger than 0 parts by mass and equal to or smaller than 3 parts by mass of carbon nanotubes.

4. The vibration-isolating device according to claim 3, wherein a mixing ratio of the carbon nanotubes in the at least one vibration-isolating rubber is equal to or larger than 1 parts by mass and is equal to or smaller than 2 parts by mass per 100 parts by mass of the silicone rubber.
